(19) United States
(12) Patent Application Publication
(10) Pub. No.: US 2021/0241291 A1
(43) Pub. Date: Aug. 5, 2021

(54) PRODUCT INFORMATION PROVIDING SYSTEM AND SERVICE INFORMATION PROVIDING SYSTEM

(71) Applicant: SUNAO NET CO., LTD., Itoshima-shi (JP)

(72) Inventors: Daikichi SUEMATSU, Itoshima-shi (JP); Junko YAMAGUCHI, Ukiha-shi (JP)

(21) Appl. No.: 16/972,548

(22) PCT Filed: Mar. 17, 2020
(86) PCT No.: PCT/JP2020/011588

§ 371 Date: Dec. 4, 2020

(30) Foreign Application Priority Data
Mar. 22, 2019 (JP) 2019-055663

(51) Int. Cl. G06Q 30/02; G06N 20/00

(52) U.S. Cl. CPC G06Q 30/0201; G06N 20/00; G06Q 30/0283; G06Q 30/0202

(57) ABSTRACT

A merchandise provider information recording means that records merchandise provider information transmitted from a merchandise provider terminal, an information provider information recording means that records information provider information transmitted from an information provider terminal, an accessory information outputting means, and point granting means are included.

### FIELD OF THE INVENTION

The present invention relates to a product information providing system and a service information providing system. Specifically, the present invention relates to a product information providing system and a service information providing system by which a consumer is enabled to select a merchandise or a service with a sense of security.

### BACKGROUND ART

The safety of food products and other merchandises has been a focus of attention of consumers from before and when a consumer selects a merchandise, the consumer is now interested even in what sort of object the merchandise itself or a raw material of the merchandise is.

A provider of a merchandise thus provides the merchandise with information such as components and place of origin of the provided merchandise or raw material of the merchandise, date of manufacture, etc., being indicated on a label or recorded on an IC tag adhered to a packaging of the merchandise.

However, with simply providing an object indicating or recording information upon attachment to a merchandise, alteration or forgery, etc., of the information is easy and there in fact have been actual cases of alteration or forgery, etc., of information being performed such that trustworthiness among consumers is low and it was difficult for consumer to select merchandises with a sense of security.

The inventor of the present invention has thus proposed an art of providing a food product not simply upon attaching an object indicating or recording information to the food product but upon attaching to the food product a raw material powder sample with which raw materials of the food product are made into a powder (see Patent Literature 1).

### CITATION LIST

### Patent Literature

Patent Literature 1: Japanese Published Unexamined Patent Application No. 2009-5656

### SUMMARY OF THE INVENTION

### Technical Problem

Incidentally, the quality of various merchandises including food products or the quality of various services is strongly influenced by various factors in the process until the merchandise or service is provided to a consumer.

Therefore, although a raw material powder sample of a food product is a factor by which information on the quality of the food product can be obtained, it is merely one factor and the art described in Patent Literature 1 of providing a food product upon attaching a raw material powder sample to the food product is, in some cases, not sufficient by itself for realizing the object of a consumer selecting a merchandise or service with a sense of security.

The present invention has been made in view of the above point and an object thereof is to provide a product information providing system and a service information providing system by which a consumer is enabled to select a merchandise or a service with a sense of security even more sufficiently.

### Solution to Problem

To achieve the above object, a product information providing system according to the present invention includes a merchandise provider information recording means that records, as merchandise provider information, information transmitted from a terminal of a merchandise provider and including information on a content of a specific merchandise, an information provider information recording means that records, as information provider information, information transmitted from a terminal of an information provider differing from the merchandise provider and including the information on the content of the merchandise provided from the merchandise provider and information on an accessory for understanding of quality of the merchandise provided from the merchandise provider, an accessory information outputting means that outputs the information on the accessory included in selected information provider information that is information provider information selected by the merchandise provider from among the information provider information recorded in the information provider information recording means or identification information enabling access to the information on the accessory, a point granting means that grants a point to the information provider for whom the information on the accessory is used by the accessory information outputting means outputting the information, and an AI information recording means that records specific information as AI information by artificial intelligence based on information that is at least a portion of the merchandise provider information or at least a portion of the information provider information or at least a portion of the merchandise provider information and at least a portion of the information provider information or an AI information outputting means that outputs specific information as AI information by artificial intelligence based on information that is at least a portion of the merchandise provider information recorded in the merchandise provider information recording means or at least a portion of the information provider information recorded in the information provider information recording means or at least a portion of the merchandise provider information recorded in the merchandise provider information recording means and at least a portion of the information provider information recorded in the information provider information recording means.

Here, by the information on the content of the specific merchandise being recorded as the merchandise provider information in the merchandise provider information recording means, the content of the specific merchandise that the merchandise provider provided to the information provider can be specified.

Also, by the information on the content of the merchandise provided from the merchandise provider being recorded as the information provider information in the information provider information recording means, the content of the specific merchandise that the information provider was provided with from the merchandise provider can be specified.

Hence, by the specifying of the content of the specific merchandise being performed based on the information of both the party providing the merchandise (merchandise provider) and the party provided therewith (information provider), alteration or forgery, etc., of information can be suppressed. That is, alteration or forgery, etc., of information can be suppressed by the information that should be the same in content (information on the content of the specific merchandise) being recorded from both the party providing the information (merchandise provider) and the party provided therewith (information provider). Here, if the merchandise provider information recording means differs from the information provider information recording means, alteration or forgery, etc., of information can be suppressed even further.

Also, by the information on the accessory being recorded as the information provider information in the information provider information recording means, the quality of the merchandise provided from the merchandise provider can be specified.

Here, if the information on the accessory is recorded as the merchandise provider information in the merchandise provider information recording means, the quality of the merchandise provided by the merchandise provider can be specified.

Hence, by the specifying of the quality of the specific merchandise being performed based on the information of both the party providing the merchandise (merchandise provider) and the party provided therewith (information provider), alteration or forgery, etc., of information can be suppressed. That is, alteration or forgery, etc., of information can be suppressed by the information that should be the same in content (information on the accessory) being recorded from both the party providing the merchandise (merchandise provider) and the party provided with the merchandise (information provider). Here, if the merchandise provider information recording means differs from the information provider information recording means, alteration or forgery, etc., of information can be suppressed even further.

Also, by the accessory information outputting means outputting the information on the accessory included in the selected information provider information or the identification information enabling access to the information on the accessory, a consumer can ascertain the quality of the merchandise provided to the information provider from the merchandise provider.

Further, by the point granting means granting the point to the information provider for whom the information on the accessory is used, an incentive of the information provider to want the information on the accessory to be used can be enhanced.

Also, since a subject for which the point is granted is the information provider information selected by the merchandise provider, in other words, since just the information provider information selected by the merchandise provider is used, competition is generated among information providers wanting information provider information to be used and quality improvement of the information on the accessory included in the information provider information can be anticipated even further. Here, the information provider information selected by the merchandise provider may be singular or plural.

Here, if, the AI information recording means is included, the AI information provided by artificial intelligence can also be recorded in addition to information transmitted from the terminal of the merchandise provider and information transmitted from the terminal of the information provider. Also, a user who accesses the AI information recording means can obtain the AI information. On the other hand, if the AI information outputting means is provided, the AI information provided by artificial intelligence can be provided to the user.

Also, if information on a return rate is recorded as the information provider information in the information provider information recording means, the return rate when the accessory is used can be specified.

Here, the information provider information is information transmitted from the terminal of the information provider and thus, to put it in another way, it can be anticipated that the incentive of the information provider to want the information on the accessory to be used would be enhanced by the information on the return rate being determined and recorded in the information provider information recording means by the information provider him/herself. Hence, in accompaniment with such enhancement of incentive, improvement of the quality of the information on the accessory included in the information provider information can also be anticipated.

Also, by the accessory information outputting means outputting information on another merchandise included in the selected information provider information or identification information enabling access to the information on the other merchandise, the consumer can compare the merchandise provided by the merchandise provider and the other merchandise to ascertain the quality.

Also, to achieve the above object, a product information providing system according to the present invention includes an information provider information recording means that records, as information provider information, information transmitted from a terminal of an information provider differing from a merchandise provider and including information on an accessory for understanding of quality of a merchandise provided from the merchandise provider, an accessory information outputting means that outputs the information on the accessory included in selected information provider information that is information provider information selected by the merchandise provider from among the information provider information recorded in the information provider information recording means or identification information enabling access to the information on the accessory, a point granting means that grants a point to the information provider for whom the information on the accessory is used by the accessory information outputting means outputting the information, and an AI information recording means that records specific information as AI information by artificial intelligence based on information that is at least a portion of the information provider information or an AI information outputting means that outputs specific information as AI information by artificial intelligence based on information that is at least a portion of the information provider information recorded in the information provider information recording means.

Here, by the information on the accessory being recorded as the information provider information in the information provider information recording means, the quality of the merchandise provided from the merchandise provider can be specified.

Also, by the accessory information outputting means outputting the information on the accessory included in the selected information provider information or the identification information enabling access to the information on the accessory, a consumer can ascertain the quality of the merchandise provided to the information provider from the merchandise provider.

Further, by the point granting means granting the point to the information provider for whom the information on the accessory is used, an incentive of the information provider to want the information on the accessory to be used can be enhanced.

Also, since a subject for which the point is granted is the information provider information selected by the merchandise provider, in other words, since just the information provider information selected by the merchandise provider is used, competition is generated among information providers wanting information provider information to be used and quality improvement of the information on the accessory included in the information provider information can be anticipated even further. Here, the information provider information selected by the merchandise provider may be singular or plural.

Here, if, the AI information recording means is included, the AI information provided by artificial intelligence can also be recorded in addition to information transmitted from the terminal of the merchandise provider and information transmitted from the terminal of the information provider. Also, a user who accesses the AI information recording means can obtain the AI information. On the other hand, if the AI information outputting means is provided, the AI information provided by artificial intelligence can be provided to the user.

Also, if information on a return rate is recorded as the information provider information in the information provider information recording means, the return rate when the accessory is used can be specified.

Here, the information provider information is information transmitted from the terminal of the information provider and thus, to put it in another way, it can be anticipated that the incentive of the information provider to want the information on the accessory to be used would be enhanced by the information on the return rate being determined and recorded in the information provider information recording means by the information provider him/herself. Hence, in accompaniment with such enhancement of incentive, improvement of the quality of the information on the accessory included in the information provider information can also be anticipated.

Also, by the accessory information outputting means outputting information on another merchandise included in the selected information provider information or identification information enabling access to the information on the other merchandise, the consumer can compare the merchandise provided by the merchandise provider and the other merchandise to ascertain the quality.

Also, to achieve the above object, a service information providing system according to the present invention includes a service provider information recording means that records, as service provider information, information transmitted from a terminal of a service provider and including information on a content of a specific service, an information provider information recording means that records, as information provider information, information transmitted from a terminal of an information provider differing from the service provider and including the information on the content of the service provided from the service provider and information on an accessory for understanding of quality of the service provided from the service provider, an accessory information outputting means that outputs the information on the accessory included in selected information provider information that is information provider information selected by the service provider from among the information provider information recorded in the information provider information recording means or identification information enabling access to the information on the accessory, a point granting means that grants a point to the information provider for whom the information on the accessory is used by the accessory information outputting means outputting the information, and an AI information recording means that records specific information as AI information by artificial intelligence based on information that is at least a portion of the service provider information or at least a portion of the information provider information or at least a portion of the service provider information and at least a portion of the information provider information or an AI information outputting means that outputs specific information as AI information by artificial intelligence based on information that is at least a portion of the service provider information recorded in the service provider information recording means or at least a portion of the information provider information recorded in the information provider information recording means or at least a portion of the service provider information recorded in the service provider information recording means and at least a portion of the information provider information recorded in the information provider information recording means.

Here, by the information on the content of the specific service being recorded as the service provider information in the service provider information recording means, the content of the specific service that the service provider provided to the information provider can be specified.

Also, by the information on the content of the service provided from the service provider being recorded as the information provider information in the information provider information recording means, the content of the specific service that the information provider was provided with from the service provider can be specified.

Hence, by the specifying of the content of the specific service being performed based on the information of both the party providing the service (service provider) and the party provided therewith (information provider), alteration or forgery, etc., of information can be suppressed. That is, alteration or forgery, etc., of information can be suppressed by the information that should be the same in content (information on the content of the specific service) being recorded from both the party providing the information (service provider) and the party provided therewith (information provider). Here, if the service provider information recording means differs from the information provider information recording means, alteration or forgery, etc., of information can be suppressed even further.

Also, by the information on the accessory being recorded as the information provider information in the information provider information recording means, the quality of the service provided from the service provider can be specified.

Here, if the information on the accessory is recorded as the service provider information in the service provider information recording means, the quality of the service provided by the service provider can be specified.

Hence, by the specifying of the quality of the specific service being performed based on the information of both the party providing the service (service provider) and the party provided therewith (information provider), alteration or forgery, etc., of information can be suppressed. That is, alteration or forgery, etc., of information can be suppressed by the information that should be the same in content (information on the accessory) being recorded from both the party providing the service (service provider) and the party provided with the service (information provider). Here, if the service provider information recording means differs from the information provider information recording means, alteration or forgery, etc., of information can be suppressed even further.

Also, by the accessory information outputting means outputting the information on the accessory included in the selected information provider information or the identification information enabling access to the information on the accessory, a consumer can ascertain the quality of the service provided to the information provider from the service provider.

Further, by the point granting means granting the point to the information provider for whom the information on the accessory is used, an incentive of the information provider to want the information on the accessory to be used can be enhanced.

Also, since a subject for which the point is granted is the information provider information selected by the service provider, in other words, since just the information provider information selected by the service provider is used, competition is generated among information providers wanting information provider information to be used and quality improvement of the information on the accessory included in the information provider information can be anticipated even further. Here, the information provider information selected by the service provider may be singular or plural.

Here, if, the AI information recording means is included, the AI information provided by artificial intelligence can also be recorded in addition to the information transmitted from the terminal of the service provider and the information transmitted from the terminal of the information provider. Also, a user who accesses the AI information recording means can obtain the AI information. On the other hand, if the AI information outputting means is provided, the AI information provided by artificial intelligence can be provided to the user.

Also, if information on a return rate is recorded as the information provider information in the information provider information recording means, the return rate when the accessory is used can be specified.

Here, the information provider information is information transmitted from the terminal of the information provider and thus, to put it in another way, it can be anticipated that the incentive of the information provider to want the information on the accessory to be used would be enhanced by the information on the return rate being determined and recorded in the information provider information recording means by the information provider him/herself. Hence, in accompaniment with such enhancement of incentive, improvement of the quality of the information on the accessory included in the information provider information can also be anticipated.

Also, by the accessory information outputting means outputting information on another service included in the selected information provider information or identification information enabling access to the information on the other service, the consumer can compare the service provided by the service provider and the other service to ascertain the quality.

Also, to achieve the above object, a service information providing system according to the present invention includes an information provider information recording means that records, as information provider information, information transmitted from a terminal of an information provider differing from a service provider and including information on an accessory for understanding of quality of a service provided from the service provider, an accessory information outputting means that outputs the information on the accessory included in selected information provider information that is information provider information selected by the service provider from among the information provider information recorded in the information provider information recording means or identification information enabling access to the information on the accessory, a point granting means that grants a point to the information provider for whom the information on the accessory is used by the accessory information outputting means outputting the information, and an AI information recording means that records specific information as AI information by artificial intelligence based on information that is at least a portion of the information provider information or an AI information outputting means that outputs specific information as AI information by artificial intelligence based on information that is at least a portion of the information provider information recorded in the information provider information recording means.

Here, by the information on the accessory being recorded as the information provider information in the information provider information recording means, the quality of the service provided from the service provider can be specified.

Also, by the accessory information outputting means outputting the information on the accessory included in the selected information provider information or the identification information enabling access to the information on the accessory, a consumer can ascertain the quality of the service provided to the information provider from the service provider.

Further, by the point granting means granting the point to the information provider for whom the information on the accessory is used, an incentive of the information provider to want the information on the accessory to be used can be enhanced.

Also, since a subject for which the point is granted is the information provider information selected by the service provider, in other words, since just the information provider information selected by the service provider is used, competition is generated among information providers wanting information provider information to be used and quality improvement of the information on the accessory included in the information provider information can be anticipated even further. Here, the information provider information selected by the service provider may be singular or plural.

Here, if, the AI information recording means is included, the AI information provided by artificial intelligence can also be recorded in addition to the information transmitted from the terminal of the service provider and the information transmitted from the terminal of the information provider. Also, a user who accesses the AI information recording means can obtain the AI information. On the other hand, if the AI information outputting means is provided, the AI information provided by artificial intelligence can be provided to the user.

Also, if information on a return rate is recorded as the information provider information in the information provider information recording means, the return rate when the accessory is used can be specified.

Here, the information provider information is information transmitted from the terminal of the information provider and thus, to put it in another way, it can be anticipated that the incentive of the information provider to want the information on the accessory to be used would be enhanced by the information on the return rate being determined and recorded in the information provider information recording means by the information provider him/herself. Hence, in accompaniment with such enhancement of incentive, improvement of the quality of the information on the accessory included in the information provider information can also be anticipated.

Also, by the accessory information outputting means outputting information on another service included in the selected information provider information or identification information enabling access to the information on the other service, the consumer can compare the service provided by the service provider and the other service to ascertain the quality.

Also, to achieve the above object, a product information providing system according to the present invention includes a merchandise provider information recording means that records, as merchandise provider information, information transmitted from a terminal of a merchandise provider and including information on a content of a specific merchandise, an information provider information recording means that records, as information provider information, information transmitted from a terminal of an information provider differing from the merchandise provider and including the information on the content of the merchandise provided from the merchandise provider and information on an accessory for understanding of contract that has at least one of either information on a price of the merchandise provided from the merchandise provider or information on a contract content for the merchandise to be provided from the merchandise provider, an accessory information outputting means that outputs the information on the accessory included in selected information provider information that is information provider information selected by the merchandise provider from among the information provider information recorded in the information provider information recording means or identification information enabling access to the information on the accessory, a point granting means that grants a point to the information provider for whom the information on the accessory is used by the accessory information outputting means outputting the information, and an AI information recording means that records specific information as AI information by artificial intelligence based on information that is at least a portion of the merchandise provider information or at least a portion of the information provider information or at least a portion of the merchandise provider information and at least a portion of the information provider information or an AI information outputting means that outputs specific information as AI information by artificial intelligence based on information that is at least a portion of the merchandise provider information recorded in the merchandise provider information recording means or at least a portion of the information provider information recorded in the information provider information recording means or at least a portion of the merchandise provider information recorded in the merchandise provider information recording means and at least a portion of the information provider information recorded in the information provider information recording means.

Here, by the information on the content of the specific merchandise being recorded as the merchandise provider information in the merchandise provider information recording means, the content of the specific merchandise that the merchandise provider provided to the information provider can be specified.

Also, by the information on the content of the merchandise provided from the merchandise provider being recorded as the information provider information in the information provider information recording means, the content of the specific merchandise that the information provider was provided with from the merchandise provider can be specified.

Hence, by the specifying of the content of the specific merchandise being performed based on the information of both the party providing the merchandise (merchandise provider) and the party provided therewith (information provider), alteration or forgery, etc., of information can be suppressed. That is, alteration or forgery, etc., of information can be suppressed by the information that should be the same in content (information on the content of the specific merchandise) being recorded from both the party providing the information (merchandise provider) and the party provided therewith (information provider). Here, if the merchandise provider information recording means differs from the information provider information recording means, alteration or forgery, etc., of information can be suppressed even further.

Also, if the information on the accessory is recorded as the information provider information in the merchandise provider information recording means, the price of the merchandise provided by the merchandise provider and the contract content for the merchandise provider to provide the merchandise can be specified.

Here, if the information on the accessory is recorded as the merchandise provider information in the merchandise provider information recording means, the price of the merchandise provided by the merchandise provider and the contract content for the merchandise provider to provide the merchandise can be specified.

Hence, by the specifying of the price or the contract content of the specific merchandise being performed based on the information of both the party providing the merchandise (merchandise provider) and the party provided therewith (information provider), alteration or forgery, etc., of information can be suppressed. That is, alteration or forgery, etc., of information can be suppressed by the information that should be the same in content (information on the accessory) being recorded from both the party providing the merchandise (merchandise provider) and the party provided with the merchandise (information provider). Here, if the merchandise provider information recording means differs from the information provider information recording means, alteration or forgery, etc., of information can be suppressed even further.

Also, by the accessory information outputting means outputting the information on the accessory included in the selected information provider information or the identification information enabling access to the information on the accessory, a consumer can ascertain the price or the contract content of the merchandise provided to the information provider from the merchandise provider.

Further, by the point granting means granting the point to the information provider for whom the information on the accessory is used, an incentive of the information provider to want the information on the accessory to be used can be enhanced.

Also, since a subject for which the point is granted is the information provider information selected by the merchandise provider, in other words, since just the information provider information selected by the merchandise provider is used, competition is generated among information providers wanting information provider information to be used and quality improvement of the information on the accessory included in the information provider information can be anticipated even further. Here, the information provider information selected by the merchandise provider may be singular or plural.

Here, if, the AI information recording means is included, the AI information provided by artificial intelligence can also be recorded in addition to information transmitted from the terminal of the merchandise provider and information transmitted from the terminal of the information provider. Also, a user who accesses the AI information recording means can obtain the AI information. On the other hand, if the AI information outputting means is provided, the AI information provided by artificial intelligence can be provided to the user.

Also, if information on a return rate is recorded as the information provider information in the information provider information recording means, the return rate when the accessory is used can be specified.

Here, the information provider information is information transmitted from the terminal of the information provider and thus, to put it in another way, it can be anticipated that the incentive of the information provider to want the information on the accessory to be used would be enhanced by the information on the return rate being determined and recorded in the information provider information recording means by the information provider him/herself. Hence, in accompaniment with such enhancement of incentive, improvement of the quality of the information on the accessory included in the information provider information can also be anticipated.

Also, by the accessory information outputting means outputting information on another merchandise included in the selected information provider information or identification information enabling access to the information on the other merchandise, the consumer can compare the merchandise provided by the merchandise provider and the other merchandise to ascertain the price or the contract content of the merchandise.

Also, to achieve the above object, a product information providing system according to the present invention includes an information provider information recording means that records, as information provider information, information transmitted from a terminal of an information provider differing from a merchandise provider and including information on an accessory for understanding of contract that has at least one of either information on a price of a merchandise provided from the merchandise provider or information on a contract content for the merchandise to be provided from the merchandise provider, an accessory information outputting means that outputs the information on the accessory included in selected information provider information that is information provider information selected by the merchandise provider from among the information provider information recorded in the information provider information recording means or identification information enabling access to the information on the accessory, a point granting means that grants a point to the information provider for whom the information on the accessory is used by the accessory information outputting means outputting the information, and an AI information recording means that records specific information as AI information by artificial intelligence based on information that is at least a portion of the information provider information or an AI information outputting means that outputs specific information as AI information by artificial intelligence based on information that is at least a portion of the information provider information recorded in the information provider information recording means.

Here, by the information on the accessory being recorded as the information provider information in the information provider information recording means, the price or the contract content of the merchandise provided by the merchandise provider can be specified.

Also, by the accessory information outputting means outputting the information on the accessory included in the selected information provider information or the identification information enabling access to the information on the accessory, a consumer can ascertain the price or the contract content of the merchandise provided to the information provider from the merchandise provider.

Further, by the point granting means granting the point to the information provider for whom the information on the accessory is used, an incentive of the information provider to want the information on the accessory to be used can be enhanced.

Also, since a subject for which the point is granted is the information provider information selected by the merchandise provider, in other words, since just the information provider information selected by the merchandise provider is used, competition is generated among information providers wanting information provider information to be used and quality improvement of the information on the accessory included in the information provider information can be anticipated even further. Here, the information provider information selected by the merchandise provider may be singular or plural.

Here, if, the AI information recording means is included, the AI information provided by artificial intelligence can also be recorded in addition to information transmitted from the terminal of the merchandise provider and information transmitted from the terminal of the information provider. Also, a user who accesses the AI information recording means can obtain the AI information. On the other hand, if the AI information outputting means is provided, the AI information provided by artificial intelligence can be provided to the user.

Also, if information on a return rate is recorded as the information provider information in the information provider information recording means, the return rate when the accessory is used can be specified.

Here, the information provider information is information transmitted from the terminal of the information provider and thus, to put it in another way, it can be anticipated that the incentive of the information provider to want the information on the accessory to be used would be enhanced by the information on the return rate being determined and recorded in the information provider information recording means by the information provider him/herself. Hence, in accompaniment with such enhancement of incentive, improvement of the quality of the information on the accessory included in the information provider information can also be anticipated.

Also, by the accessory information outputting means outputting information on another merchandise included in the selected information provider information or identification information enabling access to the information on the other merchandise, the consumer can compare the merchandise provided by the merchandise provider and the other merchandise to ascertain the price or the contract content of the merchandise.

Also, to achieve the above object, a service information providing system according to the present invention includes a service provider information recording means that records, as service provider information, information transmitted from a terminal of a service provider and including information on a content of a specific service, an information provider information recording means that records, as information provider information, information transmitted from a terminal of an information provider differing from the service provider and including the information on the content of the service provided from the service provider and information on an accessory for understanding of contract that has at least one of either information on a price of the service provided from the service provider or information on a contract content for the service to be provided from the service provider, an accessory information outputting means that outputs the information on the accessory included in selected information provider information that is information provider information selected by the service provider from among the information provider information recorded in the information provider information recording means or identification information enabling access to the information on the accessory, a point granting means that grants a point to the information provider for whom the information on the accessory is used by the accessory information outputting means outputting the information, and an AI information recording means that records specific information as AI information by artificial intelligence based on information that is at least a portion of the service provider information or at least a portion of the information provider information or at least a portion of the service provider information and at least a portion of the information provider information or an AI information outputting means that outputs specific information as AI information by artificial intelligence based on information that is at least a portion of the service provider information recorded in the service provider information recording means or at least a portion of the information provider information recorded in the information provider information recording means or at least a portion of the service provider information recorded in the service provider information recording means and at least a portion of the information provider information recorded in the information provider information recording means.

Here, by the information on the content of the specific service being recorded as the service provider information in the service provider information recording means, the content of the specific service that the service provider provided to the information provider can be specified.

Also, by the information on the content of the service provided from the service provider being recorded as the information provider information in the information provider information recording means, the content of the specific service that the information provider was provided with from the service provider can be specified.

Hence, by the specifying of the content of the specific service being performed based on the information of both the party providing the service (service provider) and the party provided therewith (information provider), alteration or forgery, etc., of information can be suppressed. That is, alteration or forgery, etc., of information can be suppressed by the information that should be the same in content (information on the content of the specific service) being recorded from both the party providing the information (service provider) and the party provided therewith (information provider). Here, if the service provider information recording means differs from the information provider information recording means, alteration or forgery, etc., of information can be suppressed even further.

Also, by the information on the accessory being recorded as the information provider information in the information provider information recording means, the price of the service provided by the service provider and the contract content for the service to be provided from the service provider can be specified.

Here, if the information on the accessory is recorded as the service provider information in the service provider information recording means, the price of the service provided by the service provider and the contract content for the service provider to provide the service can be specified.

Hence, by the specifying of the price or the contract content of the specific service being performed based on the information of both the party providing the service (service provider) and the party provided therewith (information provider), alteration or forgery, etc., of information can be suppressed. That is, alteration or forgery, etc., of information can be suppressed by the information that should be the same in content (information on the accessory) being recorded from both the party providing the service (service provider) and the party provided with the service (information provider). Here, if the service provider information recording means differs from the information provider information recording means, alteration or forgery, etc., of information can be suppressed even further.

Also, by the accessory information outputting means outputting the information on the accessory included in the selected information provider information or the identification information enabling access to the information on the accessory, a consumer can ascertain the price or the contract content of the service provided to the information provider from the service provider.

Further, by the point granting means granting the point to the information provider for whom the information on the accessory is used, an incentive of the information provider to want the information on the accessory to be used can be enhanced.

Also, since a subject for which the point is granted is the information provider information selected by the service provider, in other words, since just the information provider information selected by the service provider is used, competition is generated among information providers wanting information provider information to be used and quality improvement of the information on the accessory included in the information provider information can be anticipated even further. Here, the information provider information selected by the service provider may be singular or plural.

Here, if, the AI information recording means is included, the AI information provided by artificial intelligence can also be recorded in addition to the information transmitted from the terminal of the service provider and the information transmitted from the terminal of the information provider. Also, a user who accesses the AI information recording means can obtain the AI information. On the other hand, if the AI information outputting means is provided, the AI information provided by artificial intelligence can be provided to the user.

Also, if information on a return rate is recorded as the information provider information in the information provider information recording means, the return rate when the accessory is used can be specified.

Here, the information provider information is information transmitted from the terminal of the information provider and thus, to put it in another way, it can be anticipated that the incentive of the information provider to want the information on the accessory to be used would be enhanced by the information on the return rate being determined and recorded in the information provider information recording means by the information provider him/herself. Hence, in accompaniment with such enhancement of incentive, improvement of the quality of the information on the accessory included in the information provider information can also be anticipated.

Also, by the accessory information outputting means outputting information on another service included in the selected information provider information or identification information enabling access to the information on the other service, the consumer can compare the service provided by the service provider and the other service to ascertain the price or the contract content of the service.

Also, to achieve the above object, a service information providing system according to the present invention includes an information provider information recording means that records, as information provider information, information transmitted from a terminal of an information provider differing from a service provider and including information on an accessory for understanding of contract that has at least one of either information on a price of a service provided from the service provider or information on a contract content for the service to be provided from the service provider, an accessory information outputting means that outputs the information on the accessory included in selected information provider information that is information provider information selected by the service provider from among the information provider information recorded in the information provider information recording means or identification information enabling access to the information on the accessory, a point granting means that grants a point to the information provider for whom the information on the accessory is used by the accessory information outputting means outputting the information, and an AI information recording means that records specific information as AI information by artificial intelligence based on information that is at least a portion of the information provider information or an AI information outputting means that outputs specific information as AI information by artificial intelligence based on information that is at least a portion of the information provider information recorded in the information provider information recording means.

Here, by the information on the accessory being recorded as the information provider information in the information provider information recording means, the price or the contract content of the service provided by the service provider can be specified.

Also, by the accessory information outputting means outputting the information on the accessory included in the selected information provider information or the identification information enabling access to the information on the accessory, a consumer can ascertain the price or the contract content of the service provided to the information provider from the service provider.

Further, by the point granting means granting the point to the information provider for whom the information on the accessory is used, an incentive of the information provider to want the information on the accessory to be used can be enhanced.

Also, since a subject for which the point is granted is the information provider information selected by the service provider, in other words, since just the information provider information selected by the service provider is used, competition is generated among information providers wanting information provider information to be used and quality improvement of the information on the accessory included in the information provider information can be anticipated even further. Here, the information provider information selected by the service provider may be singular or plural.

Here, if, the AI information recording means is included, the AI information provided by artificial intelligence can also be recorded in addition to the information transmitted from the terminal of the service provider and the information transmitted from the terminal of the information provider. Also, a user who accesses the AI information recording means can obtain the AI information. On the other hand, if the AI information outputting means is provided, the AI information provided by artificial intelligence can be provided to the user.

Also, if information on a return rate is recorded as the information provider information in the information provider information, the return rate when the accessory is used can be specified.

Here, the information provider information is information transmitted from the terminal of the information provider and thus, to put it in another way, it can be anticipated that the incentive of the information provider to want the information on the accessory to be used would be enhanced by the information on the return rate being determined and recorded in the information provider information recording means by the information provider him/herself. Hence, in accompaniment with such enhancement of incentive, improvement of the quality of the information on the accessory included in the information provider information can also be anticipated.

Also, by the accessory information outputting means outputting information on another service included in the selected information provider information or identification information enabling access to the information on the other service, the consumer can compare the service provided by the service provider and the other service to ascertain the price or the contract content of the service.

Incidentally, the “specific merchandise” here also includes a food product. Also, the “specific merchandise” includes both a case where it is a primary product and a case where it is a secondary product and includes both a case where it is a tangible object and a case where it is an intangible object.

Also, the “specific service” here refers to various services performed for a customer and to making efforts for others and may be chargeable or free of charge.

Also, the “identification information enabling access to the information on the accessory” refers, for example, to an identifier such as a two-dimensional barcode, a color code, etc., that enables access to a website on which the information on the accessory is posted via a communication line.

Further, the “point” here refers to a point that can be exchanged with a free gift or merchandise or be discounted by or be appropriated for a portion of a price of a subsequent or later purchase and includes both a point that is redeemable in cash and a point that is not redeemable in cash.

Also, as the “information on an accessory for understanding of quality of a merchandise” when the “specific merchandise” is a food product (primary product) or as the “information on an accessory for understanding of quality of a service” when the “specific service” is processing of a food product (primary product), for example, information on the accessories indicated below can be cited. Here, in regard to an accessory for a merchandise (primary product) other than a food product or for processing of a merchandise (primary product) other than a food product, “food product” in the description of the following accessories shall be replaced by “merchandise.”

[Accessory 1 of Primary Product]

At least one among a soil, water, a seawater, a seabed water, an alkaline water, salt collected from a seabed water, a seabed mud, a seaweed, a fertilizer, a soil disinfectant, a bactericide, an antibacterial agent, an agricultural chemical, a seed, a living organism in soil, a living organism in water, a grass, a culturing feed, an insect, a repellant plant, a feed, a lean meat agent, an antibiotic, a growth hormone agent, and a vinyl of substantially equivalent quality to a vinyl for greenhouse that are involved in production of the specific food product.

[Accessory 2 of Primary Product]

A soil prior to sowing or seedling planting at a production site of the specific food product and the soil after harvesting at the production site of the specific food product.

[Accessory 3 of Primary Product]

An object having a main body of an object involved in production that is at least one among a soil, water, a seawater, a seabed water, an alkaline water, salt collected from seabed water, and a seaweed that are involved in production of the specific food product and collection site information that is information on a collection site of the main body of the object involved in production.

[Accessory 4 of Primary Product]

A grass obtained at a production site of the specific food product.

[Accessory 5 of Primary Product]

At least one among a grass that is a feed of foreign origin involved in production of the specific food product, a grass that is a feed of domestic origin involved in production of the specific food product, a grain feed of foreign origin involved in production of the specific food product and a grain feed of domestic origin involved in production of the specific food product.

[Accessory 6 of Primary Product]

An object that is substantially the same as a feed involved in production of the specific food product and with which a grain portion and an antibiotic and growth hormone agent portion are arranged in separate states.

[Accessory 7 of Primary Product]

A substitutional food product grown separately of the specific food product under substantially the same conditions as the specific food product.

[Accessory 8 of Primary Product]

A powder of a substitutional food product grown separately of the specific food product under substantially the same conditions as the specific food product.

[Accessory 9 of Primary Product]

A processed product of a substitutional food product grown separately of the specific food product under substantially the same conditions as the specific food product.

[Accessory 10 of Primary Product]

A powder processed product of a substitutional food product grown separately of the specific food product under substantially the same conditions as the specific food product.

[Accessory 11 of Primary Product]

A substitutional integrally grown object grown integrally with a substitutional food product grown separately of the specific food product under substantially the same conditions as the specific food product.

[Accessory 12 of Primary Product]

A powder of a substitutional integrally grown object grown integrally with a substitutional food product grown separately of the specific food product under substantially the same conditions as the specific food product.

[Accessory 13 of Primary Product]

A processed product of a substitutional integrally grown object grown integrally with a substitutional food product grown separately of the specific food product under substantially the same conditions as the specific food product.

[Accessory 14 of Primary Product]

A powder processed product of a substitutional integrally grown object grown integrally with a substitutional food product grown separately of the specific food product under substantially the same conditions as the specific food product.

[Accessory 15 of Primary Product]

A portion, differing from the specific food product, of an integrally grown object grown integrally with the specific food product or a portion, differing from a portion corresponding to the specific food product, of a substitutional integrally grown object grown integrally with a substitutional food product grown separately of the specific food product under substantially the same conditions as the specific food product.

[Accessory 16 of Primary Product]

A powder of a portion, differing from the specific food product, of an integrally grown object grown integrally with the specific food product or a powder of a portion, differing from a portion corresponding to the specific food product, of a substitutional integrally grown object grown integrally with a substitutional food product grown separately of the specific food product under substantially the same conditions as the specific food product.

[Accessory 17 of Primary Product]

A processed product of a portion, differing from the specific food product, of an integrally grown object grown integrally with the specific food product or a processed product of a portion, differing from a portion corresponding to the specific food product, of a substitutional integrally grown object grown integrally with a substitutional food product grown separately of the specific food product under substantially the same conditions as the specific food product.

[Accessory 18 of Primary Product]

A powder processed product of a portion, differing from the specific food product, of an integrally grown object grown integrally with the specific food product or a powder processed product of a portion, differing from a portion corresponding to the specific food product, of a substitutional integrally grown object grown integrally with a substitutional food product grown separately of the specific food product under substantially the same conditions as the specific food product.

[Accessory 19 of Primary Product]

A seed of a next generation to the specific food product or a seed of a next generation to a substitutional food product grown separately of the specific food product under substantially the same conditions as the specific food product.

[Accessory 20 of Primary Product]

A seed tuber obtained from a portion of the specific food product or from a substitutional food product grown separately of the specific food product under substantially the same conditions as the specific food product.

[Accessory 21 of Primary Product]

An object having a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 22 of Primary Product]

An object arranged by a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 23 of Primary Product]

An object having a powder of a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 24 of Primary Product]

An object arranged by a powder of a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 25 of Primary Product]

An object having a processed product of a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 26 of Primary Product]

An object arranged by a processed product of a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 27 of Primary Product]

An object having a powder processed product of a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 28 of Primary Product]

An object arranged by a powder processed product of a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 29 of Primary Product]

An object having a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 30 of Primary Product]

An object arranged by a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 31 of Primary Product]

An object having a powder of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 32 of Primary Product]

An object arranged by a powder of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 33 of Primary Product]

An object having a processed product of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 34 of Primary Product]

An object arranged by a processed product of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 35 of Primary Product]

An object having a powder processed product of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 36 of Primary Product]

An object arranged by a powder processed product of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 37 of Primary Product]

An object having a portion, differing from the specific food product, of an integrally grown object grown integrally with the specific food product or a portion, differing from a portion corresponding to the specific food product, of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 38 of Primary Product]

An object arranged by a portion, differing from the specific food product, of an integrally grown object grown integrally with the specific food product or a portion, differing from a portion corresponding to the specific food product, of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 39 of Primary Product]

An object having a powder of a portion, differing from the specific food product, of an integrally grown object grown integrally with the specific food product or a powder of a portion, differing from a portion corresponding to the specific food product, of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 40 of Primary Product]

An object arranged by a powder of a portion, differing from the specific food product, of an integrally grown object grown integrally with the specific food product or a powder of a portion, differing from a portion corresponding to the specific food product, of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 41 of Primary Product]

An object having a processed product of a portion, differing from the specific food product, of an integrally grown object grown integrally with the specific food product or a processed product of a portion, differing from a portion corresponding to the specific food product, of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 42 of Primary Product]

An object arranged by a processed product of a portion, differing from the specific food product, of an integrally grown object grown integrally with the specific food product or a processed product of a portion, differing from a portion corresponding to the specific food product, of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 43 of Primary Product]

An object having a powder processed product of a portion, differing from the specific food product, of an integrally grown object grown integrally with the specific food product or a powder processed product of a portion, differing from a portion corresponding to the specific food product, of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 44 of Primary Product]

An object arranged by a powder processed product of a portion, differing from the specific food product, of an integrally grown object grown integrally with the specific food product or a powder processed product of a portion, differing from a portion corresponding to the specific food product, of a substitutional integrally grown object grown integrally with a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 45 of Primary Product]

An object having a seed of a next generation to the specific food product or a seed of a next generation to a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 46 of Primary Product]

An object arranged by a seed of a next generation to the specific food product or a seed of a next generation to a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 47 of Primary Product]

An object having a seed tuber obtained from a portion of the specific food product or from a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 48 of Primary Product]

An object arranged by a seed tuber obtained from a portion of the specific food product or from a substitutional food product grown separately of the specific food product under substantially the same conditions as the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 49 of Primary Product]

An object arranged by an accessory main body that is a portion of the specific food product or is a substitutional food product grown separately of the specific food product under substantially the same conditions as the specific food product or is a portion, differing from the specific food product, of an integrally grown object grown integrally with the specific food product or is a portion, differing from a portion corresponding to the specific food product, of a substitutional integrally grown object grown integrally with a substitutional food product grown separately of the specific food product under substantially the same conditions as the specific food product being contained together with water.

[Accessory 50 of Primary Product]

An object arranged by an accessory main body that is a portion of the specific food product or is a substitutional food product grown separately of the specific food product under substantially the same conditions as the specific food product or is a portion, differing from the specific food product, of an integrally grown object grown integrally with the specific food product or is a portion, differing from a portion corresponding to the specific food product, of a substitutional integrally grown object grown integrally with a substitutional food product grown separately of the specific food product under substantially the same conditions as the specific food product being contained together with water and having an ammonia sensor.

[Accessory 51 of Primary Product]

An agricultural chemical used after harvesting of the specific food product.

[Accessory 52 of Primary Product]

At least one of a fumigant, a disinfectant, a bactericide, an antibacterial agent, a fungicide, an antiseptic, a coating, an antioxidant, a herbicide, an insecticide, a bleach sterilizer, or a chemical agent involved in the specific food product after production of the specific food product.

[Accessory 53 of Primary Product]

At least one of a food additive for animal or a growth hormone agent involved in the specific food product after production of the specific food product.

[Accessory 54 of Primary Product]

At least one among an algae, a grass, and a fishery product grown at substantially the same time and substantially in the same environment as production of the specific food product.

Also, as the “information on an accessory for understanding of quality of a food product” when the “specific merchandise” is a food product (secondary product) or as the “information on an accessory for understanding of quality of a service” when the “specific service” is providing of a food product (secondary product) (for example, a restaurant), for example, information on the accessories indicated below can be cited. Here, in regard to an accessory for a merchandise (secondary product) other than a food product or for providing of a merchandise (secondary product) other than a food product, “food product” in the description of the following accessories shall be replaced by “merchandise.”

[Accessory 1 of Secondary Product]

A raw material of the specific food product.

[Accessory 2 of Secondary Product]

A substitutional raw material grown separately of a raw material of the specific food product under substantially the same conditions as the raw material of the specific food product.

[Accessory 3 of Secondary Product]

A powder of a substitutional raw material grown separately of a raw material of the specific food product under substantially the same conditions as the raw material of the specific food product.

[Accessory 4 of Secondary Product]

A processed product of a substitutional raw material grown separately of a raw material of the specific food product under substantially the same conditions as the raw material of the specific food product.

[Accessory 5 of Secondary Product]

A powder processed product of a substitutional raw material grown separately of a raw material of the specific food product under substantially the same conditions as the raw material of the specific food product.

[Accessory 6 of Secondary Product]

A substitutional integrally grown object grown integrally with a substitutional raw material grown separately of a raw material of the specific food product under substantially the same conditions as the raw material of the specific food product.

[Accessory 7 of Secondary Product]

A powder of a substitutional integrally grown object grown integrally with a substitutional raw material grown separately of a raw material of the specific food product under substantially the same conditions as the raw material of the specific food product.

[Accessory 8 of Secondary Product]

A processed product of a substitutional integrally grown object grown integrally with a substitutional raw material grown separately of a raw material of the specific food product under substantially the same conditions as the raw material of the specific food product.

[Accessory 9 of Secondary Product]

A powder processed product of a substitutional integrally grown object grown integrally with a substitutional raw material grown separately of a raw material of the specific food product under substantially the same conditions as the raw material of the specific food product.

[Accessory 10 of Secondary Product]

An egg that is a raw material of the specific food product.

[Accessory 11 of Secondary Product]

A substitutional egg produced under substantially the same conditions as an egg that is a raw material of the specific food product.

[Accessory 12 of Secondary Product]

At least one of lactic acid bacteria, Lactobacillus bifidus, koji, koji mold, or Bacillus subtilis involved in production of the specific food product.

[Accessory 13 of Secondary Product]

A wood barrel, a bottle, a plastic container, or a pickling bed involved in production of the specific food product.

[Accessory 14 of Secondary Product]

At least one among a soil, water, a seawater, a seabed water, an alkaline water, salt collected from a seabed water, a seabed mud, a seaweed, salt, a fertilizer, a soil disinfectant, a bactericide, an antibacterial agent, an agricultural chemical, a seed, a living organism in soil, a living organism in water, a grass, a culturing feed, an insect, a repellant plant, a feed, a lean meat agent, an antibiotic, a growth hormone agent, and a vinyl of substantially equivalent quality to a vinyl for greenhouse that are involved in production of a raw material of the specific food product.

[Accessory 15 of Secondary Product]

A soil prior to sowing or seedling planting at a production site of a raw material of the specific food product and the soil after harvesting at the production site of the raw material of the specific food product.

[Accessory 16 of Secondary Product]

An object having a main body of an object involved in production that is at least one among a soil, water, a seawater, a seabed water, an alkaline water, salt collected from seabed water, and a seaweed that are involved in production of a raw material of the specific food product and collection site information that is information on a collection site of the main body of the object involved in production.

[Accessory 17 of Secondary Product]

A grass obtained at a production site of a raw material of the specific food product.

[Accessory 18 of Secondary Product]

At least one among a grass that is a feed of foreign origin involved in production of a raw material of the specific food product, a grass that is a feed of domestic origin involved in production of the raw material of the specific food product, a grain feed of foreign origin involved in production of the raw material of the specific food product and a grain feed of domestic origin involved in production of the raw material of the specific food product.

[Accessory 19 of Secondary Product]

An object that is substantially the same as a feed involved in production of a raw material of the specific food product and with which a grain portion and an antibiotic and growth hormone agent portion are arranged in separate states.

[Accessory 20 of Secondary Product]

At least one of a wood chip of a wood barrel involved in production of the specific food product, a wood chip of a wood barrel of substantially the same conditions as the wood barrel involved in production of the specific food product, a wood chip of the same type as a constituent material of the wood barrel involved in production of the specific food product, a wood chip being of the same type as a constituent material of the wood barrel with which the specific food product is produced and placed together with the specific food product inside the wood barrel, a liquid contained in the specific food product, or a liquid involved in production of the specific food product.

[Accessory 21 of Secondary Product]

A portion, differing from a raw material of the specific food product, of an integrally grown object grown integrally with the raw material of the specific food product or a portion, differing from a portion corresponding to the raw material of the specific food product, of a substitutional integrally grown object grown integrally with a substitutional raw material grown separately of the raw material of the specific food product under substantially the same conditions as the raw material of the specific food product.

[Accessory 22 of Secondary Product]

A powder of a portion, differing from a raw material of the specific food product, of an integrally grown object grown integrally with the raw material of the specific food product or a powder of a portion, differing from a portion corresponding to the raw material of the specific food product, of a substitutional integrally grown object grown integrally with a substitutional raw material grown separately of the raw material of the specific food product under substantially the same conditions as the raw material of the specific food product.

[Accessory 23 of Secondary Product]

A processed product of a portion, differing from a raw material of the specific food product, of an integrally grown object grown integrally with the raw material of the specific food product or a processed product of a portion, differing from a portion corresponding to the raw material of the specific food product, of a substitutional integrally grown object grown integrally with a substitutional raw material grown separately of the raw material of the specific food product under substantially the same conditions as the raw material of the specific food product.

[Accessory 24 of Secondary Product]

A powder processed product of a portion, differing from a raw material of the specific food product, of an integrally grown object grown integrally with the raw material of the specific food product or a powder processed product of a portion, differing from a portion corresponding to the raw material of the specific food product, of a substitutional integrally grown object grown integrally with a substitutional raw material grown separately of the raw material of the specific food product under substantially the same conditions as the raw material of the specific food product.

[Accessory 25 of Secondary Product]

At least one among a food additive of the same weight as a total weight of the food additive used in the specific food product, a dummy of the same weight as the total weight of the food additive used in the specific food product, the food additive of the same volume as a total volume of the food additive used in the specific food product, a dummy of the same volume as the total volume of the food additive used in the specific food product, the food additive of apparently the same volume as the total volume of the food additive used in the specific food product, a dummy of apparently the same volume as the total volume of the food additive used in the specific food product, sugar of the same weight as a total weight of the sugar used in the specific food product, a dummy of the same weight as the total weight of the sugar used in the specific food product, the sugar of the same volume as a total volume of the sugar used in the specific food product, a dummy of the same volume as the total volume of the sugar used in the specific food product, the sugar of apparently the same volume as the total volume of the sugar used in the specific food product, a dummy of apparently the same volume as the total volume of the sugar used in the specific food product, salt of the same weight as a total weight of the salt used in the specific food product, a dummy of the same weight as the total weight of the salt used in the specific food product, the salt of the same volume as a total volume of the salt used in the specific food product, a dummy of the same volume as the total volume of the salt used in the specific food product, the salt of apparently the same volume as the total volume of the salt used in the specific food product, a dummy of apparently the same volume as the total volume of the salt used in the specific food product, a hydrolyzed protein of the same weight as a total weight of the hydrolyzed protein used in the specific food product, a dummy of the same weight as the total weight of the hydrolyzed protein used in the specific food product, the hydrolyzed protein of the same volume as a total volume of the hydrolyzed protein used in the specific food product, a dummy of the same volume as the total volume of the hydrolyzed protein used in the specific food product, the hydrolyzed protein of apparently the same volume as the total volume of the hydrolyzed protein used in the specific food product, a dummy of apparently the same volume as the total volume of the hydrolyzed protein used in the specific food product, a seasoning of the same weight as a total weight of the seasoning used in the specific food product, a dummy of the same weight as the total weight of the seasoning used in the specific food product, the seasoning of the same volume as a total volume of the seasoning used in the specific food product, a dummy of the same volume as the total volume of the seasoning used in the specific food product, the seasoning of apparently the same volume as the total volume of the seasoning used in the specific food product, a dummy of apparently the same volume as the total volume of the seasoning used in the specific food product, a high-fructose corn syrup of the same weight as a total weight of the high-fructose corn syrup used in the specific food product, a dummy of the same weight as the total weight of the high-fructose corn syrup used in the specific food product, the high-fructose corn syrup of the same volume as a total volume of the high-fructose corn syrup used in the specific food product, a dummy of the same volume as the total volume of the high-fructose corn syrup used in the specific food product, the high-fructose corn syrup of apparently the same volume as the total volume of the high-fructose corn syrup used in the specific food product, a dummy of apparently the same volume as the total volume of the high-fructose corn syrup used in the specific food product, a processed oil or fat of the same weight as a total weight of the processed oil or fat used in the specific food product, a dummy of the same weight as the total weight of the processed oil or fat used in the specific food product, the processed oil or fat of the same volume as a total volume of the processed oil or fat used in the specific food product, a dummy of the same volume as the total volume of the processed oil or fat used in the specific food product, the processed oil or fat of apparently the same volume as the total volume of the processed oil or fat used in the specific food product, a dummy of apparently the same volume as the total volume of the processed oil or fat used in the specific food product, a trans fatty acid of the same weight as a total weight of the trans fatty acid used in the specific food product, a dummy of the same weight as the total weight of the trans fatty acid used in the specific food product, the trans fatty acid of the same volume as a total volume of the trans fatty acid used in the specific food product, a dummy of the same volume as the total volume of the trans fatty acid used in the specific food product, the trans fatty acid of apparently the same volume as the total volume of the trans fatty acid used in the specific food product, a dummy of apparently the same volume as the total volume of the trans fatty acid used in the specific food product, a processed starch of the same weight as a total weight of the processed starch used in the specific food product, a dummy of the same weight as the total weight of the processed starch used in the specific food product, the processed starch of the same volume as a total volume of the processed starch used in the specific food product, a dummy of the same volume as the total volume of the processed starch used in the specific food product, the processed starch of apparently the same volume as the total volume of the processed starch used in the specific food product, a dummy of apparently the same volume as the total volume of the processed starch used in the specific food product, a food additive of the same weight as a total weight of the food additive for which, among food additives used in the specific food product, indication of a collective name is allowed, a dummy of the same weight as the total weight of the food additive for which, among the food additives used in the specific food product, indication of the collective name is allowed, the food additive of the same volume as a total volume of the food additive for which, among the food additives used in the specific food product, indication of the collective name is allowed, a dummy of the same volume as the total volume of the food additive for which, among the food additives used in the specific food product, indication of the collective name is allowed, the food additive of apparently the same volume as the total volume of the food additive for which, among the food additives used in the specific food product, indication of the collective name is allowed, a dummy of apparently the same volume as the total volume of the food additive for which, among the food additives used in the specific food product, indication of the collective name is allowed, a synthetic vitamin of the same weight as a total weight of the synthetic vitamin used in the specific food product, a dummy of the same weight as the total weight of the synthetic vitamin used in the specific food product, the synthetic vitamin of the same volume as a total volume of the synthetic vitamin used in the specific food product, a dummy of the same volume as the total volume of the synthetic vitamin used in the specific food product, the synthetic vitamin of apparently the same volume as the total volume of the synthetic vitamin used in the specific food product, a dummy of apparently the same volume as the total volume of the synthetic vitamin used in the specific food product, a food additive of the same weight as a total weight of the food additive that, among food additives used in the specific food product, is deemed to be a carry over, a dummy of the same weight as the total weight of the food additive that, among the food additives used in the specific food product, is deemed to be the carry over, the food additive of the same volume as a total volume of the food additive that, among the food additives used in the specific food product, is deemed to be the carry over, a dummy of the same volume as the total volume of the food additive that, among the food additives used in the specific food product, is deemed to be the carry over, the food additive of apparently the same volume as the total volume of the food additive that, among the food additives used in the specific food product, is deemed to be the carry over, a dummy of apparently the same volume as the total volume of the food additive that, among the food additives used in the specific food product, is deemed to be the carry over, a food additive of the same weight as a total weight of the food additive among food additives used in the specific food product excluding a food additive deemed to be a carry over, a dummy of the same weight as the total weight of the food additive among the food additives used in the specific food product excluding the food additive deemed to be the carry over, the food additive of the same volume as a total volume of the food additive among the food additives used in the specific food product excluding the food additive deemed to be the carry over, a dummy of the same volume as the total volume of the food additive among the food additives used in the specific food product excluding the food additive deemed to be the carry over, the food additive of apparently the same volume as the total volume of the food additive among the food additives used in the specific food product excluding the food additive deemed to be the carry over, a dummy of apparently the same volume as the total volume of the food additive among the food additives used in the specific food product excluding the food additive deemed to be the carry over, a defatted soybean of the same weight as a total weight of the defatted soybean used in the specific food product, a dummy of the same weight as the total weight of the defatted soybean used in the specific food product, the defatted soybean of the same volume as a total volume of the defatted soybean used in the specific food product, a dummy of the same volume as the total volume of the defatted soybean used in the specific food product, the defatted soybean of apparently the same volume as the total volume of the defatted soybean used in the specific food product, a dummy of apparently the same volume as the total volume of the defatted soybean used in the specific food product, a phosphate of the same weight as a total weight of the phosphate used in the specific food product, a dummy of the same weight as the total weight of the phosphate used in the specific food product, the phosphate of the same volume as a total volume of the phosphate used in the specific food product, a dummy of the same volume as the total volume of the phosphate used in the specific food product, the phosphate of apparently the same volume as the total volume of the phosphate used in the specific food product, a dummy of apparently the same volume as the total volume of the phosphate used in the specific food product, sorbic acid of the same weight as a total weight of the sorbic acid used in the specific food product, a dummy of the same weight as the total weight of the sorbic acid used in the specific food product, the sorbic acid of the same volume as a total volume of the sorbic acid used in the specific food product, a dummy of the same volume as the total volume of the sorbic acid used in the specific food product, the sorbic acid of apparently the same volume as the total volume of the sorbic acid used in the specific food product, a dummy of apparently the same volume as the total volume of the sorbic acid used in the specific food product, aspartame of the same weight as a total weight of the aspartame used in the specific food product, a dummy of the same weight as the total weight of the aspartame used in the specific food product, the aspartame of the same volume as a total volume of the aspartame used in the specific food product, a dummy of the same volume as the total volume of the aspartame used in the specific food product, the aspartame of apparently the same volume as the total volume of the aspartame used in the specific food product and a dummy of apparently the same volume as the total volume of the aspartame used in the specific food product.

[Accessory 26 of Secondary Product]

At least a portion of a food additive used in the specific food product that is classified according to a specific function or according to a specific application.

[Accessory 27 of Secondary Product]

At least one among a food additive of the same weight as a weight obtained by multiplying a predetermined ratio to a total weight of the food additive used in the specific food product, a dummy of the same weight as the weight obtained by multiplying the predetermined ratio to the total weight of the food additive used in the specific food product, the food additive of the same volume as a volume obtained by multiplying a predetermined ratio to a total volume of the food additive used in the specific food product, a dummy of the same volume as the volume obtained by multiplying the predetermined ratio to the total volume of the food additive used in the specific food product, the food additive of apparently the same volume as the volume obtained by multiplying the predetermined ratio to the total volume of the food additive used in the specific food product, a dummy of apparently the same volume as the volume obtained by multiplying the predetermined ratio to the total volume of the food additive used in the specific food product, sugar of the same weight as a weight obtained by multiplying a predetermined ratio to a total weight of the sugar used in the specific food product, a dummy of the same weight as the weight obtained by multiplying the predetermined ratio to the total weight of the sugar used in the specific food product, the sugar of the same volume as a volume obtained by multiplying a predetermined ratio to a total volume of the sugar used in the specific food product, a dummy of the same volume as the volume obtained by multiplying the predetermined ratio to the total volume of the sugar used in the specific food product, the sugar of apparently the same volume as the volume obtained by multiplying the predetermined ratio to the total volume of the sugar used in the specific food product, a dummy of apparently the same volume as the volume obtained by multiplying the predetermined ratio to the total volume of the sugar used in the specific food product, salt of the same weight as a weight obtained by multiplying a predetermined ratio to a total weight of the salt used in the specific food product, a dummy of the same weight as the weight obtained by multiplying the predetermined ratio to the total weight of the salt used in the specific food product, the salt of the same volume as a volume obtained by multiplying a predetermined ratio to a total volume of the salt used in the specific food product, a dummy of the same volume as the volume obtained by multiplying the predetermined ratio to the total volume of the salt used in the specific food product, the salt of apparently the same volume as the volume obtained by multiplying the predetermined ratio to the total volume of the salt used in the specific food product, a dummy of apparently the same volume as the volume obtained by multiplying the predetermined ratio to the total volume of the salt used in the specific food product, a hydrolyzed protein of the same weight as a weight obtained by multiplying a predetermined ratio to a total weight of the hydrolyzed protein used in the specific food product, a dummy of the same weight as the weight obtained by multiplying the predetermined ratio to the total weight of the hydrolyzed protein used in the specific food product, the hydrolyzed protein of the same volume as a volume obtained by multiplying a predetermined ratio to a total volume of the hydrolyzed protein used in the specific food product, a dummy of the same volume as the volume obtained by multiplying the predetermined ratio to the total volume of the hydrolyzed protein used in the specific food product, the hydrolyzed protein of apparently the same volume as the volume obtained by multiplying the predetermined ratio to the total volume of the hydrolyzed protein used in the specific food product, a dummy of apparently the same volume as the volume obtained by multiplying the predetermined ratio to the total volume of the hydrolyzed protein used in the specific food product, a seasoning of the same weight as a weight obtained by multiplying a predetermined ratio to a total weight of the seasoning used in the specific food product, a dummy of the same weight as the weight obtained by multiplying the predetermined ratio to the total weight of the seasoning used in the specific food product, the seasoning of the same volume as a volume obtained by multiplying a predetermined ratio to a total volume of the seasoning used in the specific food product, a dummy of the same volume as the volume obtained by multiplying the predetermined ratio to the total volume of the seasoning used in the specific food product, the seasoning of apparently the same volume as the volume obtained by multiplying the predetermined ratio to the total volume of the seasoning used in the specific food product, a dummy of apparently the same volume as the volume obtained by multiplying the predetermined ratio to the total volume of the seasoning used in the specific food product, a high-fructose corn syrup of the same weight as a weight obtained by multiplying a predetermined ratio to a total weight of the high-fructose corn syrup used in the specific food product, a dummy of the same weight as the weight obtained by multiplying the predetermined ratio to the total weight of the high-fructose corn syrup used in the specific food product, the high-fructose corn syrup of the same volume as a volume obtained by multiplying a predetermined ratio to a total volume of the high-fructose corn syrup used in the specific food product, a dummy of the same volume as the volume obtained by multiplying the predetermined ratio to the total volume of the high-fructose corn syrup used in the specific food product, the high-fructose corn syrup of apparently the same volume as the volume obtained by multiplying the predetermined ratio to the total volume of the high-fructose corn syrup used in the specific food product, a dummy of apparently the same volume as the volume obtained by multiplying the predetermined ratio to the total volume of the high-fructose corn syrup used in the specific food product, a processed oil or fat of the same weight as a weight obtained by multiplying a predetermined ratio to a total weight of the processed oil or fat used in the specific food product, a dummy of the same weight as the weight obtained by multiplying the predetermined ratio to the total weight of the processed oil or fat used in the specific food product, the processed oil or fat of the same volume as a volume obtained by multiplying a predetermined ratio to a total volume of the processed oil or fat used in the specific food product, a dummy of the same volume as the volume obtained by multiplying the predetermined ratio to the total volume of the processed oil or fat used in the specific food product, the processed oil or fat of apparently the same volume as the volume obtained by multiplying the predetermined ratio to the total volume of the processed oil or fat used in the specific food product, a dummy of apparently the same volume as the volume obtained by multiplying the predetermined ratio to the total volume of the processed oil or fat used in the specific food product, a trans fatty acid of the same weight as a weight obtained by multiplying a predetermined ratio to a total weight of the trans fatty acid used in the specific food product, a dummy of the same weight as the weight obtained by multiplying the predetermined ratio to the total weight of the trans fatty acid used in the specific food product, the trans fatty acid of the same volume as a volume obtained by multiplying a predetermined ratio to a total volume of the trans fatty acid used in the specific food product, a dummy of the same volume as the volume obtained by multiplying the predetermined ratio to the total volume of the trans fatty acid used in the specific food product, the trans fatty acid of apparently the same volume as the volume obtained by multiplying the predetermined ratio to the total volume of the trans fatty acid used in the specific food product, a dummy of apparently the same volume as the volume obtained by multiplying the predetermined ratio to the total volume of the trans fatty acid used in the specific food product, a processed starch of the same weight as a weight obtained by multiplying a predetermined ratio to a total weight of the processed starch used in the specific food product, a dummy of the same weight as the weight obtained by multiplying the predetermined ratio to the total weight of the processed starch used in the specific food product, the processed starch of the same volume as a volume obtained by multiplying a predetermined ratio to a total volume of the processed starch used in the specific food product, a dummy of the same volume as the volume obtained by multiplying the predetermined ratio to the total volume of the processed starch used in the specific food product, the processed starch of apparently the same volume as the volume obtained by multiplying the predetermined ratio to the total volume of the processed starch used in the specific food product, a dummy of apparently the same volume as the volume obtained by multiplying the predetermined ratio to the total volume of the processed starch used in the specific food product, a food additive of the same weight as a weight obtained by multiplying a predetermined ratio to a total weight of the food additive for which, among food additives used in the specific food product, indication of a collective name is allowed, a dummy of the same weight as the weight obtained by multiplying the predetermined ratio to the total weight of the food additive for which, among the food additives used in the specific food product, indication of the collective name is allowed, the food additive of the same volume as a volume obtained by multiplying a predetermined ratio to a total volume of the food additive for which, among the food additives used in the specific food product, indication of the collective name is allowed, a dummy of the same volume as the volume obtained by multiplying the predetermined ratio to the total volume of the food additive for which, among the food additives used in the specific food product, indication of the collective name is allowed, the food additive of apparently the same volume as the volume obtained by multiplying the predetermined ratio to the total volume of the food additive for which, among the food additives used in the specific food product, indication of the collective name is allowed, a dummy of apparently the same volume as the volume obtained by multiplying the predetermined ratio to the total volume of the food additive for which, among the food additives used in the specific food product, indication of the collective name is allowed, a synthetic vitamin of the same weight as a weight obtained by multiplying a predetermined ratio to a total weight of the synthetic vitamin used in the specific food product, a dummy of the same weight as the weight obtained by multiplying the predetermined ratio to the total weight of the synthetic vitamin used in the specific food product, the synthetic vitamin of the same volume as a volume obtained by multiplying a predetermined ratio to a total volume of the synthetic vitamin used in the specific food product, a dummy of the same volume as the volume obtained by multiplying the predetermined ratio to the total volume of the synthetic vitamin used in the specific food product, the synthetic vitamin of apparently the same volume as the volume obtained by multiplying the predetermined ratio to the total volume of the synthetic vitamin used in the specific food product, a dummy of apparently the same volume as the volume obtained by multiplying the predetermined ratio to the total volume of the synthetic vitamin used in the specific food product, a food additive of the same weight as a weight obtained by multiplying a predetermined ratio to a total weight of the food additive that, among food additives used in the specific food product, is deemed to be a carry over, a dummy of the same weight as the weight obtained by multiplying the predetermined ratio to the total weight of the food additive that, among the food additives used in the specific food product, is deemed to be the carry over, the food additive of the same volume as a volume obtained by multiplying a predetermined ratio to a total volume of the food additive that, among the food additives used in the specific food product, is deemed to be the carry over, a dummy of the same volume as the volume obtained by multiplying the predetermined ratio to the total volume of the food additive that, among the food additives used in the specific food product, is deemed to be the carry over, the food additive of apparently the same volume as the volume obtained by multiplying the predetermined ratio to the total volume of the food additive that, among the food additives used in the specific food product, is deemed to be the carry over, a dummy of apparently the same volume as the volume obtained by multiplying the predetermined ratio to the total volume of the food additive that, among the food additives used in the specific food product, is deemed to be the carry over, a food additive of the same weight as a weight obtained by multiplying a predetermined ratio to a total weight of the food additive among food additives used in the specific food product excluding a food additive deemed to be a carry over, a dummy of the same weight as the weight obtained by multiplying the predetermined ratio to the total weight of the food additive among the food additives used in the specific food product excluding the food additive deemed to be the carry over, the food additive of the same volume as a volume obtained by multiplying a predetermined ratio to a total volume of the food additive among the food additives used in the specific food product excluding the food additive deemed to be the carry over, a dummy of the same volume as the volume obtained by multiplying the predetermined ratio to the total volume of the food additive among the food additives used in the specific food product excluding the food additive deemed to be the carry over, the food additive of apparently the same volume as the volume obtained by multiplying the predetermined ratio to the total volume of the food additive among the food additives used in the specific food product excluding the food additive deemed to be the carry over, a dummy of apparently the same volume as the volume obtained by multiplying the predetermined ratio to the total volume of the food additive among the food additives used in the specific food product excluding the food additive deemed to be the carry over, a defatted soybean of the same weight as a weight obtained by multiplying a predetermined ratio to a total weight of the defatted soybean used in the specific food product, a dummy of the same weight as the weight obtained by multiplying the predetermined ratio to the total weight of the defatted soybean used in the specific food product, the defatted soybean of the same volume as a volume obtained by multiplying a predetermined ratio to a total volume of the defatted soybean used in the specific food product, a dummy of the same volume as the volume obtained by multiplying the predetermined ratio to the total volume of the defatted soybean used in the specific food product, the defatted soybean of apparently the same volume as the volume obtained by multiplying the predetermined ratio to the total volume of the defatted soybean used in the specific food product, a dummy of apparently the same volume as the volume obtained by multiplying the predetermined ratio to the total volume of the defatted soybean used in the specific food product, a phosphate of the same weight as a weight obtained by multiplying a predetermined ratio to a total weight of the phosphate used in the specific food product, a dummy of the same weight as the weight obtained by multiplying the predetermined ratio to the total weight of the phosphate used in the specific food product, the phosphate of the same volume as a volume obtained by multiplying a predetermined ratio to a total volume of the phosphate used in the specific food product, a dummy of the same volume as the volume obtained by multiplying the predetermined ratio to the total volume of the phosphate used in the specific food product, the phosphate of apparently the same volume as the volume obtained by multiplying the predetermined ratio to the total volume of the phosphate used in the specific food product, a dummy of apparently the same volume as the volume obtained by multiplying the predetermined ratio to the total volume of the phosphate used in the specific food product, sorbic acid of the same weight as a weight obtained by multiplying a predetermined ratio to a total weight of the sorbic acid used in the specific food product, a dummy of the same weight as the weight obtained by multiplying the predetermined ratio to the total weight of the sorbic acid used in the specific food product, the sorbic acid of the same volume as a volume obtained by multiplying a predetermined ratio to a total volume of the sorbic acid used in the specific food product, a dummy of the same volume as the volume obtained by multiplying the predetermined ratio to the total volume of the sorbic acid used in the specific food product, the sorbic acid of apparently the same volume as the volume obtained by multiplying the predetermined ratio to the total volume of the sorbic acid used in the specific food product, a dummy of apparently the same volume as the volume obtained by multiplying the predetermined ratio to the total volume of the sorbic acid used in the specific food product, aspartame of the same weight as a weight obtained by multiplying a predetermined ratio to a total weight of the aspartame used in the specific food product, a dummy of the same weight as the weight obtained by multiplying the predetermined ratio to the total weight of the aspartame used in the specific food product, the aspartame of the same volume as a volume obtained by multiplying a predetermined ratio to a total volume of the aspartame used in the specific food product, a dummy of the same volume as the volume obtained by multiplying the predetermined ratio to the total volume of the aspartame used in the specific food product, the aspartame of apparently the same volume as the volume obtained by multiplying the predetermined ratio to the total volume of the aspartame used in the specific food product and a dummy of apparently the same volume as the volume obtained by multiplying the predetermined ratio to the total volume of the aspartame used in the specific food product and an indicating object indicating the predetermined ratio.

[Accessory 28 of Secondary Product]

A seed of a next generation to a raw material of the specific food product or a seed of a next generation to a substitutional raw material grown separately of the raw material of the specific food product under substantially the same conditions as the raw material of the specific food product.

[Accessory 29 of Secondary Product]

A seed tuber obtained from a portion of a raw material of the specific food product or from a substitutional raw material grown separately of the raw material of the specific food product under substantially the same conditions as the raw material of the specific food product.

[Accessory 30 of Secondary Product]

An object having a raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 31 of Secondary Product]

An object arranged by a raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 32 of Secondary Product]

An object having a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 33 of Secondary Product]

An object arranged by a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 34 of Secondary Product]

An object having a powder of a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 35 of Secondary Product]

An object arranged by a powder of a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 36 of Secondary Product]

An object having a processed product of a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 37 of Secondary Product]

An object arranged by a processed product of a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 38 of Secondary Product]

An object having a powder processed product of a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 39 of Secondary Product]

An object arranged by a powder processed product of a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 40 of Secondary Product]

An object having a substitutional integrally grown object grown integrally with a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 41 of Secondary Product]

An object arranged by a substitutional integrally grown object grown integrally with a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 42 of Secondary Product]

An object having a powder of a substitutional integrally grown object grown integrally with a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 43 of Secondary Product]

An object arranged by a powder of a substitutional integrally grown object grown integrally with a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 44 of Secondary Product]

An object having a processed product of a substitutional integrally grown object grown integrally with a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 45 of Secondary Product]

An object arranged by a processed product of a substitutional integrally grown object grown integrally with a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 46 of Secondary Product]

An object having a powder processed product of a substitutional integrally grown object grown integrally with a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 47 of Secondary Product]

An object arranged by a powder processed product of a substitutional integrally grown object grown integrally with a substitutional raw material grown separately of a raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 48 of Secondary Product]

An object having a portion, differing from a raw material of the specific food product, of an integrally grown object grown integrally with the raw material of the specific food product or a portion, differing from a portion corresponding to the raw material of the specific food product, of a substitutional integrally grown object grown integrally with a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 49 of Secondary Product]

An object arranged by a portion, differing from a raw material of the specific food product, of an integrally grown object grown integrally with the raw material of the specific food product or a portion, differing from a portion corresponding to the raw material of the specific food product, of a substitutional integrally grown object grown integrally with a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 50 of Secondary Product]

An object having a powder of a portion, differing from a raw material of the specific food product, of an integrally grown object grown integrally with the raw material of the specific food product or a powder of a portion, differing from a portion corresponding to the raw material of the specific food product, of a substitutional integrally grown object grown integrally with a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 51 of Secondary Product]

An object arranged by a powder of a portion, differing from a raw material of the specific food product, of an integrally grown object grown integrally with the raw material of the specific food product or a powder of a portion, differing from a portion corresponding to the raw material of the specific food product, of a substitutional integrally grown object grown integrally with a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 52 of Secondary Product]

An object having a processed product of a portion, differing from a raw material of the specific food product, of an integrally grown object grown integrally with the raw material of the specific food product or a processed product of a portion, differing from a portion corresponding to the raw material of the specific food product, of a substitutional integrally grown object grown integrally with a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 53 of Secondary Product]

An object arranged by a processed product of a portion, differing from a raw material of the specific food product, of an integrally grown object grown integrally with the raw material of the specific food product or a processed product of a portion, differing from a portion corresponding to the raw material of the specific food product, of a substitutional integrally grown object grown integrally with a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 54 of Secondary Product]

An object having a powder processed product of a portion, differing from a raw material of the specific food product, of an integrally grown object grown integrally with the raw material of the specific food product or a powder processed product of a portion, differing from a portion corresponding to the raw material of the specific food product, of a substitutional integrally grown object grown integrally with a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 55 of Secondary Product]

An object arranged by a powder processed product of a portion, differing from a raw material of the specific food product, of an integrally grown object grown integrally with the raw material of the specific food product or a powder processed product of a portion, differing from a portion corresponding to the raw material of the specific food product, of a substitutional integrally grown object grown integrally with a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 56 of Secondary Product]

An object having at least one among a food additive of the same weight as a total weight of the food additive used in the specific food product, a dummy of the same weight as the total weight of the food additive used in the specific food product, the food additive of the same volume as a total volume of the food additive used in the specific food product, a dummy of the same volume as the total volume of the food additive used in the specific food product, the food additive of apparently the same volume as the total volume of the food additive used in the specific food product, a dummy of apparently the same volume as the total volume of the food additive used in the specific food product, sugar of the same weight as a total weight of the sugar used in the specific food product, a dummy of the same weight as the total weight of the sugar used in the specific food product, the sugar of the same volume as a total volume of the sugar used in the specific food product, a dummy of the same volume as the total volume of the sugar used in the specific food product, the sugar of apparently the same volume as the total volume of the sugar used in the specific food product, a dummy of apparently the same volume as the total volume of the sugar used in the specific food product, salt of the same weight as a total weight of the salt used in the specific food product, a dummy of the same weight as the total weight of the salt used in the specific food product, the salt of the same volume as a total volume of the salt used in the specific food product, a dummy of the same volume as the total volume of the salt used in the specific food product, the salt of apparently the same volume as the total volume of the salt used in the specific food product, a dummy of apparently the same volume as the total volume of the salt used in the specific food product, a hydrolyzed protein of the same weight as a total weight of the hydrolyzed protein used in the specific food product, a dummy of the same weight as the total weight of the hydrolyzed protein used in the specific food product, the hydrolyzed protein of the same volume as a total volume of the hydrolyzed protein used in the specific food product, a dummy of the same volume as the total volume of the hydrolyzed protein used in the specific food product, the hydrolyzed protein of apparently the same volume as the total volume of the hydrolyzed protein used in the specific food product, a dummy of apparently the same volume as the total volume of the hydrolyzed protein used in the specific food product, a seasoning of the same weight as a total weight of the seasoning used in the specific food product, a dummy of the same weight as the total weight of the seasoning used in the specific food product, the seasoning of the same volume as a total volume of the seasoning used in the specific food product, a dummy of the same volume as the total volume of the seasoning used in the specific food product, the seasoning of apparently the same volume as the total volume of the seasoning used in the specific food product, a dummy of apparently the same volume as the total volume of the seasoning used in the specific food product, a high-fructose corn syrup of the same weight as a total weight of the high-fructose corn syrup used in the specific food product, a dummy of the same weight as the total weight of the high-fructose corn syrup used in the specific food product, the high-fructose corn syrup of the same volume as a total volume of the high-fructose corn syrup used in the specific food product, a dummy of the same volume as the total volume of the high-fructose corn syrup used in the specific food product, the high-fructose corn syrup of apparently the same volume as the total volume of the high-fructose corn syrup used in the specific food product, a dummy of apparently the same volume as the total volume of the high-fructose corn syrup used in the specific food product, a processed oil or fat of the same weight as a total weight of the processed oil or fat used in the specific food product, a dummy of the same weight as the total weight of the processed oil or fat used in the specific food product, the processed oil or fat of the same volume as a total volume of the processed oil or fat used in the specific food product, a dummy of the same volume as the total volume of the processed oil or fat used in the specific food product, the processed oil or fat of apparently the same volume as the total volume of the processed oil or fat used in the specific food product, a dummy of apparently the same volume as the total volume of the processed oil or fat used in the specific food product, a trans fatty acid of the same weight as a total weight of the trans fatty acid used in the specific food product, a dummy of the same weight as the total weight of the trans fatty acid used in the specific food product, the trans fatty acid of the same volume as a total volume of the trans fatty acid used in the specific food product, a dummy of the same volume as the total volume of the trans fatty acid used in the specific food product, the trans fatty acid of apparently the same volume as the total volume of the trans fatty acid used in the specific food product, a dummy of apparently the same volume as the total volume of the trans fatty acid used in the specific food product, a processed starch of the same weight as a total weight of the processed starch used in the specific food product, a dummy of the same weight as the total weight of the processed starch used in the specific food product, the processed starch of the same volume as a total volume of the processed starch used in the specific food product, a dummy of the same volume as the total volume of the processed starch used in the specific food product, the processed starch of apparently the same volume as the total volume of the processed starch used in the specific food product, a dummy of apparently the same volume as the total volume of the processed starch used in the specific food product, a food additive of the same weight as a total weight of the food additive for which, among food additives used in the specific food product, indication of a collective name is allowed, a dummy of the same weight as the total weight of the food additive for which, among the food additives used in the specific food product, indication of the collective name is allowed, the food additive of the same volume as a total volume of the food additive for which, among the food additives used in the specific food product, indication of the collective name is allowed, a dummy of the same volume as the total volume of the food additive for which, among the food additives used in the specific food product, indication of the collective name is allowed, the food additive of apparently the same volume as the total volume of the food additive for which, among the food additives used in the specific food product, indication of the collective name is allowed, a dummy of apparently the same volume as the total volume of the food additive for which, among the food additives used in the specific food product, indication of the collective name is allowed, a synthetic vitamin of the same weight as a total weight of the synthetic vitamin used in the specific food product, a dummy of the same weight as the total weight of the synthetic vitamin used in the specific food product, the synthetic vitamin of the same volume as a total volume of the synthetic vitamin used in the specific food product, a dummy of the same volume as the total volume of the synthetic vitamin used in the specific food product, the synthetic vitamin of apparently the same volume as the total volume of the synthetic vitamin used in the specific food product, a dummy of apparently the same volume as the total volume of the synthetic vitamin used in the specific food product, a food additive of the same weight as a total weight of the food additive that, among food additives used in the specific food product, is deemed to be a carry over, a dummy of the same weight as the total weight of the food additive that, among the food additives used in the specific food product, is deemed to be the carry over, the food additive of the same volume as a total volume of the food additive that, among the food additives used in the specific food product, is deemed to be the carry over, a dummy of the same volume as the total volume of the food additive that, among the food additives used in the specific food product, is deemed to be the carry over, the food additive of apparently the same volume as the total volume of the food additive that, among the food additives used in the specific food product, is deemed to be the carry over, a dummy of apparently the same volume as the total volume of the food additive that, among the food additives used in the specific food product, is deemed to be the carry over, a food additive of the same weight as a total weight of the food additive among food additives used in the specific food product excluding a food additive deemed to be a carry over, a dummy of the same weight as the total weight of the food additive among the food additives used in the specific food product excluding the food additive deemed to be the carry over, the food additive of the same volume as a total volume of the food additive among the food additives used in the specific food product excluding the food additive deemed to be the carry over, a dummy of the same volume as the total volume of the food additive among the food additives used in the specific food product excluding the food additive deemed to be the carry over, the food additive of apparently the same volume as the total volume of the food additive among the food additives used in the specific food product excluding the food additive deemed to be the carry over, a dummy of apparently the same volume as the total volume of the food additive among the food additives used in the specific food product excluding the food additive deemed to be the carry over, a defatted soybean of the same weight as a total weight of the defatted soybean used in the specific food product, a dummy of the same weight as the total weight of the defatted soybean used in the specific food product, the defatted soybean of the same volume as a total volume of the defatted soybean used in the specific food product, a dummy of the same volume as the total volume of the defatted soybean used in the specific food product, the defatted soybean of apparently the same volume as the total volume of the defatted soybean used in the specific food product, a dummy of apparently the same volume as the total volume of the defatted soybean used in the specific food product, a phosphate of the same weight as a total weight of the phosphate used in the specific food product, a dummy of the same weight as the total weight of the phosphate used in the specific food product, the phosphate of the same volume as a total volume of the phosphate used in the specific food product, a dummy of the same volume as the total volume of the phosphate used in the specific food product, the phosphate of apparently the same volume as the total volume of the phosphate used in the specific food product, a dummy of apparently the same volume as the total volume of the phosphate used in the specific food product, sorbic acid of the same weight as a total weight of the sorbic acid used in the specific food product, a dummy of the same weight as the total weight of the sorbic acid used in the specific food product, the sorbic acid of the same volume as a total volume of the sorbic acid used in the specific food product, a dummy of the same volume as the total volume of the sorbic acid used in the specific food product, the sorbic acid of apparently the same volume as the total volume of the sorbic acid used in the specific food product, a dummy of apparently the same volume as the total volume of the sorbic acid used in the specific food product, aspartame of the same weight as a total weight of the aspartame used in the specific food product, a dummy of the same weight as the total weight of the aspartame used in the specific food product, the aspartame of the same volume as a total volume of the aspartame used in the specific food product, a dummy of the same volume as the total volume of the aspartame used in the specific food product, the aspartame of apparently the same volume as the total volume of the aspartame used in the specific food product and a dummy of apparently the same volume as the total volume of the aspartame used in the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 57 of Secondary Product]

An object arranged by at least one among a food additive of the same weight as a total weight of the food additive used in the specific food product, a dummy of the same weight as the total weight of the food additive used in the specific food product, the food additive of the same volume as a total volume of the food additive used in the specific food product, a dummy of the same volume as the total volume of the food additive used in the specific food product, the food additive of apparently the same volume as the total volume of the food additive used in the specific food product, a dummy of apparently the same volume as the total volume of the food additive used in the specific food product, sugar of the same weight as a total weight of the sugar used in the specific food product, a dummy of the same weight as the total weight of the sugar used in the specific food product, the sugar of the same volume as a total volume of the sugar used in the specific food product, a dummy of the same volume as the total volume of the sugar used in the specific food product, the sugar of apparently the same volume as the total volume of the sugar used in the specific food product, a dummy of apparently the same volume as the total volume of the sugar used in the specific food product, salt of the same weight as a total weight of the salt used in the specific food product, a dummy of the same weight as the total weight of the salt used in the specific food product, the salt of the same volume as a total volume of the salt used in the specific food product, a dummy of the same volume as the total volume of the salt used in the specific food product, the salt of apparently the same volume as the total volume of the salt used in the specific food product, a dummy of apparently the same volume as the total volume of the salt used in the specific food product, a hydrolyzed protein of the same weight as a total weight of the hydrolyzed protein used in the specific food product, a dummy of the same weight as the total weight of the hydrolyzed protein used in the specific food product, the hydrolyzed protein of the same volume as a total volume of the hydrolyzed protein used in the specific food product, a dummy of the same volume as the total volume of the hydrolyzed protein used in the specific food product, the hydrolyzed protein of apparently the same volume as the total volume of the hydrolyzed protein used in the specific food product, a dummy of apparently the same volume as the total volume of the hydrolyzed protein used in the specific food product, a seasoning of the same weight as a total weight of the seasoning used in the specific food product, a dummy of the same weight as the total weight of the seasoning used in the specific food product, the seasoning of the same volume as a total volume of the seasoning used in the specific food product, a dummy of the same volume as the total volume of the seasoning used in the specific food product, the seasoning of apparently the same volume as the total volume of the seasoning used in the specific food product, a dummy of apparently the same volume as the total volume of the seasoning used in the specific food product, a high-fructose corn syrup of the same weight as a total weight of the high-fructose corn syrup used in the specific food product, a dummy of the same weight as the total weight of the high-fructose corn syrup used in the specific food product, the high-fructose corn syrup of the same volume as a total volume of the high-fructose corn syrup used in the specific food product, a dummy of the same volume as the total volume of the high-fructose corn syrup used in the specific food product, the high-fructose corn syrup of apparently the same volume as the total volume of the high-fructose corn syrup used in the specific food product, a dummy of apparently the same volume as the total volume of the high-fructose corn syrup used in the specific food product, a processed oil or fat of the same weight as a total weight of the processed oil or fat used in the specific food product, a dummy of the same weight as the total weight of the processed oil or fat used in the specific food product, the processed oil or fat of the same volume as a total volume of the processed oil or fat used in the specific food product, a dummy of the same volume as the total volume of the processed oil or fat used in the specific food product, the processed oil or fat of apparently the same volume as the total volume of the processed oil or fat used in the specific food product, a dummy of apparently the same volume as the total volume of the processed oil or fat used in the specific food product, a trans fatty acid of the same weight as a total weight of the trans fatty acid used in the specific food product, a dummy of the same weight as the total weight of the trans fatty acid used in the specific food product, the trans fatty acid of the same volume as a total volume of the trans fatty acid used in the specific food product, a dummy of the same volume as the total volume of the trans fatty acid used in the specific food product, the trans fatty acid of apparently the same volume as the total volume of the trans fatty acid used in the specific food product, a dummy of apparently the same volume as the total volume of the trans fatty acid used in the specific food product, a processed starch of the same weight as a total weight of the processed starch used in the specific food product, a dummy of the same weight as the total weight of the processed starch used in the specific food product, the processed starch of the same volume as a total volume of the processed starch used in the specific food product, a dummy of the same volume as the total volume of the processed starch used in the specific food product, the processed starch of apparently the same volume as the total volume of the processed starch used in the specific food product, a dummy of apparently the same volume as the total volume of the processed starch used in the specific food product, a food additive of the same weight as a total weight of the food additive for which, among food additives used in the specific food product, indication of a collective name is allowed, a dummy of the same weight as the total weight of the food additive for which, among the food additives used in the specific food product, indication of the collective name is allowed, the food additive of the same volume as a total volume of the food additive for which, among the food additives used in the specific food product, indication of the collective name is allowed, a dummy of the same volume as the total volume of the food additive for which, among the food additives used in the specific food product, indication of the collective name is allowed, the food additive of apparently the same volume as the total volume of the food additive for which, among the food additives used in the specific food product, indication of the collective name is allowed, a dummy of apparently the same volume as the total volume of the food additive for which, among the food additives used in the specific food product, indication of the collective name is allowed, a synthetic vitamin of the same weight as a total weight of the synthetic vitamin used in the specific food product, a dummy of the same weight as the total weight of the synthetic vitamin used in the specific food product, the synthetic vitamin of the same volume as a total volume of the synthetic vitamin used in the specific food product, a dummy of the same volume as the total volume of the synthetic vitamin used in the specific food product, the synthetic vitamin of apparently the same volume as the total volume of the synthetic vitamin used in the specific food product, a dummy of apparently the same volume as the total volume of the synthetic vitamin used in the specific food product, a food additive of the same weight as a total weight of the food additive that, among food additives used in the specific food product, is deemed to be a carry over, a dummy of the same weight as the total weight of the food additive that, among the food additives used in the specific food product, is deemed to be the carry over, the food additive of the same volume as a total volume of the food additive that, among the food additives used in the specific food product, is deemed to be the carry over, a dummy of the same volume as the total volume of the food additive that, among the food additives used in the specific food product, is deemed to be the carry over, the food additive of apparently the same volume as the total volume of the food additive that, among the food additives used in the specific food product, is deemed to be the carry over, a dummy of apparently the same volume as the total volume of the food additive that, among the food additives used in the specific food product, is deemed to be the carry over, a food additive of the same weight as a total weight of the food additive among food additives used in the specific food product excluding a food additive deemed to be a carry over, a dummy of the same weight as the total weight of the food additive among the food additives used in the specific food product excluding the food additive deemed to be the carry over, the food additive of the same volume as a total volume of the food additive among the food additives used in the specific food product excluding the food additive deemed to be the carry over, a dummy of the same volume as the total volume of the food additive among the food additives used in the specific food product excluding the food additive deemed to be the carry over, the food additive of apparently the same volume as the total volume of the food additive among the food additives used in the specific food product excluding the food additive deemed to be the carry over, a dummy of apparently the same volume as the total volume of the food additive among the food additives used in the specific food product excluding the food additive deemed to be the carry over, a defatted soybean of the same weight as a total weight of the defatted soybean used in the specific food product, a dummy of the same weight as the total weight of the defatted soybean used in the specific food product, the defatted soybean of the same volume as a total volume of the defatted soybean used in the specific food product, a dummy of the same volume as the total volume of the defatted soybean used in the specific food product, the defatted soybean of apparently the same volume as the total volume of the defatted soybean used in the specific food product, a dummy of apparently the same volume as the total volume of the defatted soybean used in the specific food product, a phosphate of the same weight as a total weight of the phosphate used in the specific food product, a dummy of the same weight as the total weight of the phosphate used in the specific food product, the phosphate of the same volume as a total volume of the phosphate used in the specific food product, a dummy of the same volume as the total volume of the phosphate used in the specific food product, the phosphate of apparently the same volume as the total volume of the phosphate used in the specific food product, a dummy of apparently the same volume as the total volume of the phosphate used in the specific food product, sorbic acid of the same weight as a total weight of the sorbic acid used in the specific food product, a dummy of the same weight as the total weight of the sorbic acid used in the specific food product, the sorbic acid of the same volume as a total volume of the sorbic acid used in the specific food product, a dummy of the same volume as the total volume of the sorbic acid used in the specific food product, the sorbic acid of apparently the same volume as the total volume of the sorbic acid used in the specific food product, a dummy of apparently the same volume as the total volume of the sorbic acid used in the specific food product, aspartame of the same weight as a total weight of the aspartame used in the specific food product, a dummy of the same weight as the total weight of the aspartame used in the specific food product, the aspartame of the same volume as a total volume of the aspartame used in the specific food product, a dummy of the same volume as the total volume of the aspartame used in the specific food product, the aspartame of apparently the same volume as the total volume of the aspartame used in the specific food product and a dummy of apparently the same volume as the total volume of the aspartame used in the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 58 of Secondary Product]

An object having at least one among a food additive of the same weight as a weight obtained by multiplying a predetermined ratio to a total weight of the food additive used in the specific food product, a dummy of the same weight as the weight obtained by multiplying the predetermined ratio to the total weight of the food additive used in the specific food product, the food additive of the same volume as a volume obtained by multiplying a predetermined ratio to a total volume of the food additive used in the specific food product, a dummy of the same volume as the volume obtained by multiplying the predetermined ratio to the total volume of the food additive used in the specific food product, the food additive of apparently the same volume as the volume obtained by multiplying the predetermined ratio to the total volume of the food additive used in the specific food product, a dummy of apparently the same volume as the volume obtained by multiplying the predetermined ratio to the total volume of the food additive used in the specific food product, sugar of the same weight as a weight obtained by multiplying a predetermined ratio to a total weight of the sugar used in the specific food product, a dummy of the same weight as the weight obtained by multiplying the predetermined ratio to the total weight of the sugar used in the specific food product, the sugar of the same volume as a volume obtained by multiplying a predetermined ratio to a total volume of the sugar used in the specific food product, a dummy of the same volume as the volume obtained by multiplying the predetermined ratio to the total volume of the sugar used in the specific food product, the sugar of apparently the same volume as the volume obtained by multiplying the predetermined ratio to the total volume of the sugar used in the specific food product, a dummy of apparently the same volume as the volume obtained by multiplying the predetermined ratio to the total volume of the sugar used in the specific food product, salt of the same weight as a weight obtained by multiplying a predetermined ratio to a total weight of the salt used in the specific food product, a dummy of the same weight as the weight obtained by multiplying the predetermined ratio to the total weight of the salt used in the specific food product, the salt of the same volume as a volume obtained by multiplying a predetermined ratio to a total volume of the salt used in the specific food product, a dummy of the same volume as the volume obtained by multiplying the predetermined ratio to the total volume of the salt used in the specific food product, the salt of apparently the same volume as the volume obtained by multiplying the predetermined ratio to the total volume of the salt used in the specific food product, a dummy of apparently the same volume as the volume obtained by multiplying the predetermined ratio to the total volume of the salt used in the specific food product, a hydrolyzed protein of the same weight as a weight obtained by multiplying a predetermined ratio to a total weight of the hydrolyzed protein used in the specific food product, a dummy of the same weight as the weight obtained by multiplying the predetermined ratio to the total weight of the hydrolyzed protein used in the specific food product, the hydrolyzed protein of the same volume as a volume obtained by multiplying a predetermined ratio to a total volume of the hydrolyzed protein used in the specific food product, a dummy of the same volume as the volume obtained by multiplying the predetermined ratio to the total volume of the hydrolyzed protein used in the specific food product, the hydrolyzed protein of apparently the same volume as the volume obtained by multiplying the predetermined ratio to the total volume of the hydrolyzed protein used in the specific food product, a dummy of apparently the same volume as the volume obtained by multiplying the predetermined ratio to the total volume of the hydrolyzed protein used in the specific food product, a seasoning of the same weight as a weight obtained by multiplying a predetermined ratio to a total weight of the seasoning used in the specific food product, a dummy of the same weight as the weight obtained by multiplying the predetermined ratio to the total weight of the seasoning used in the specific food product, the seasoning of the same volume as a volume obtained by multiplying a predetermined ratio to a total volume of the seasoning used in the specific food product, a dummy of the same volume as the volume obtained by multiplying the predetermined ratio to the total volume of the seasoning used in the specific food product, the seasoning of apparently the same volume as the volume obtained by multiplying the predetermined ratio to the total volume of the seasoning used in the specific food product, a dummy of apparently the same volume as the volume obtained by multiplying the predetermined ratio to the total volume of the seasoning used in the specific food product, a high-fructose corn syrup of the same weight as a weight obtained by multiplying a predetermined ratio to a total weight of the high-fructose corn syrup used in the specific food product, a dummy of the same weight as the weight obtained by multiplying the predetermined ratio to the total weight of the high-fructose corn syrup used in the specific food product, the high-fructose corn syrup of the same volume as a volume obtained by multiplying a predetermined ratio to a total volume of the high-fructose corn syrup used in the specific food product, a dummy of the same volume as the volume obtained by multiplying the predetermined ratio to the total volume of the high-fructose corn syrup used in the specific food product, the high-fructose corn syrup of apparently the same volume as the volume obtained by multiplying the predetermined ratio to the total volume of the high-fructose corn syrup used in the specific food product, a dummy of apparently the same volume as the volume obtained by multiplying the predetermined ratio to the total volume of the high-fructose corn syrup used in the specific food product, a processed oil or fat of the same weight as a weight obtained by multiplying a predetermined ratio to a total weight of the processed oil or fat used in the specific food product, a dummy of the same weight as the weight obtained by multiplying the predetermined ratio to the total weight of the processed oil or fat used in the specific food product, the processed oil or fat of the same volume as a volume obtained by multiplying a predetermined ratio to a total volume of the processed oil or fat used in the specific food product, a dummy of the same volume as the volume obtained by multiplying the predetermined ratio to the total volume of the processed oil or fat used in the specific food product, the processed oil or fat of apparently the same volume as the volume obtained by multiplying the predetermined ratio to the total volume of the processed oil or fat used in the specific food product, a dummy of apparently the same volume as the volume obtained by multiplying the predetermined ratio to the total volume of the processed oil or fat used in the specific food product, a trans fatty acid of the same weight as a weight obtained by multiplying a predetermined ratio to a total weight of the trans fatty acid used in the specific food product, a dummy of the same weight as the weight obtained by multiplying the predetermined ratio to the total weight of the trans fatty acid used in the specific food product, the trans fatty acid of the same volume as a volume obtained by multiplying a predetermined ratio to a total volume of the trans fatty acid used in the specific food product, a dummy of the same volume as the volume obtained by multiplying the predetermined ratio to the total volume of the trans fatty acid used in the specific food product, the trans fatty acid of apparently the same volume as the volume obtained by multiplying the predetermined ratio to the total volume of the trans fatty acid used in the specific food product, a dummy of apparently the same volume as the volume obtained by multiplying the predetermined ratio to the total volume of the trans fatty acid used in the specific food product, a processed starch of the same weight as a weight obtained by multiplying a predetermined ratio to a total weight of the processed starch used in the specific food product, a dummy of the same weight as the weight obtained by multiplying the predetermined ratio to the total weight of the processed starch used in the specific food product, the processed starch of the same volume as a volume obtained by multiplying a predetermined ratio to a total volume of the processed starch used in the specific food product, a dummy of the same volume as the volume obtained by multiplying the predetermined ratio to the total volume of the processed starch used in the specific food product, the processed starch of apparently the same volume as the volume obtained by multiplying the predetermined ratio to the total volume of the processed starch used in the specific food product, a dummy of apparently the same volume as the volume obtained by multiplying the predetermined ratio to the total volume of the processed starch used in the specific food product, a food additive of the same weight as a weight obtained by multiplying a predetermined ratio to a total weight of the food additive for which, among food additives used in the specific food product, indication of a collective name is allowed, a dummy of the same weight as the weight obtained by multiplying the predetermined ratio to the total weight of the food additive for which, among the food additives used in the specific food product, indication of the collective name is allowed, the food additive of the same volume as a volume obtained by multiplying a predetermined ratio to a total volume of the food additive for which, among the food additives used in the specific food product, indication of the collective name is allowed, a dummy of the same volume as the volume obtained by multiplying the predetermined ratio to the total volume of the food additive for which, among the food additives used in the specific food product, indication of the collective name is allowed, the food additive of apparently the same volume as the volume obtained by multiplying the predetermined ratio to the total volume of the food additive for which, among the food additives used in the specific food product, indication of the collective name is allowed, a dummy of apparently the same volume as the volume obtained by multiplying the predetermined ratio to the total volume of the food additive for which, among the food additives used in the specific food product, indication of the collective name is allowed, a synthetic vitamin of the same weight as a weight obtained by multiplying a predetermined ratio to a total weight of the synthetic vitamin used in the specific food product, a dummy of the same weight as the weight obtained by multiplying the predetermined ratio to the total weight of the synthetic vitamin used in the specific food product, the synthetic vitamin of the same volume as a volume obtained by multiplying a predetermined ratio to a total volume of the synthetic vitamin used in the specific food product, a dummy of the same volume as the volume obtained by multiplying the predetermined ratio to the total volume of the synthetic vitamin used in the specific food product, the synthetic vitamin of apparently the same volume as the volume obtained by multiplying the predetermined ratio to the total volume of the synthetic vitamin used in the specific food product, a dummy of apparently the same volume as the volume obtained by multiplying the predetermined ratio to the total volume of the synthetic vitamin used in the specific food product, a food additive of the same weight as a weight obtained by multiplying a predetermined ratio to a total weight of the food additive that, among food additives used in the specific food product, is deemed to be a carry over, a dummy of the same weight as the weight obtained by multiplying the predetermined ratio to the total weight of the food additive that, among the food additives used in the specific food product, is deemed to be the carry over, the food additive of the same volume as a volume obtained by multiplying a predetermined ratio to a total volume of the food additive that, among the food additives used in the specific food product, is deemed to be the carry over, a dummy of the same volume as the volume obtained by multiplying the predetermined ratio to the total volume of the food additive that, among the food additives used in the specific food product, is deemed to be the carry over, the food additive of apparently the same volume as the volume obtained by multiplying the predetermined ratio to the total volume of the food additive that, among the food additives used in the specific food product, is deemed to be the carry over, a dummy of apparently the same volume as the volume obtained by multiplying the predetermined ratio to the total volume of the food additive that, among the food additives used in the specific food product, is deemed to be the carry over, a food additive of the same weight as a weight obtained by multiplying a predetermined ratio to a total weight of the food additive among food additives used in the specific food product excluding a food additive deemed to be a carry over, a dummy of the same weight as the weight obtained by multiplying the predetermined ratio to the total weight of the food additive among the food additives used in the specific food product excluding the food additive deemed to be the carry over, the food additive of the same volume as a volume obtained by multiplying a predetermined ratio to a total volume of the food additive among the food additives used in the specific food product excluding the food additive deemed to be the carry over, a dummy of the same volume as the volume obtained by multiplying the predetermined ratio to the total volume of the food additive among the food additives used in the specific food product excluding the food additive deemed to be the carry over, the food additive of apparently the same volume as the volume obtained by multiplying the predetermined ratio to the total volume of the food additive among the food additives used in the specific food product excluding the food additive deemed to be the carry over, a dummy of apparently the same volume as the volume obtained by multiplying the predetermined ratio to the total volume of the food additive among the food additives used in the specific food product excluding the food additive deemed to be the carry over, a defatted soybean of the same weight as a weight obtained by multiplying a predetermined ratio to a total weight of the defatted soybean used in the specific food product, a dummy of the same weight as the weight obtained by multiplying the predetermined ratio to the total weight of the defatted soybean used in the specific food product, the defatted soybean of the same volume as a volume obtained by multiplying a predetermined ratio to a total volume of the defatted soybean used in the specific food product, a dummy of the same volume as the volume obtained by multiplying the predetermined ratio to the total volume of the defatted soybean used in the specific food product, the defatted soybean of apparently the same volume as the volume obtained by multiplying the predetermined ratio to the total volume of the defatted soybean used in the specific food product, a dummy of apparently the same volume as the volume obtained by multiplying the predetermined ratio to the total volume of the defatted soybean used in the specific food product, a phosphate of the same weight as a weight obtained by multiplying a predetermined ratio to a total weight of the phosphate used in the specific food product, a dummy of the same weight as the weight obtained by multiplying the predetermined ratio to the total weight of the phosphate used in the specific food product, the phosphate of the same volume as a volume obtained by multiplying a predetermined ratio to a total volume of the phosphate used in the specific food product, a dummy of the same volume as the volume obtained by multiplying the predetermined ratio to the total volume of the phosphate used in the specific food product, the phosphate of apparently the same volume as the volume obtained by multiplying the predetermined ratio to the total volume of the phosphate used in the specific food product, a dummy of apparently the same volume as the volume obtained by multiplying the predetermined ratio to the total volume of the phosphate used in the specific food product, sorbic acid of the same weight as a weight obtained by multiplying a predetermined ratio to a total weight of the sorbic acid used in the specific food product, a dummy of the same weight as the weight obtained by multiplying the predetermined ratio to the total weight of the sorbic acid used in the specific food product, the sorbic acid of the same volume as a volume obtained by multiplying a predetermined ratio to a total volume of the sorbic acid used in the specific food product, a dummy of the same volume as the volume obtained by multiplying the predetermined ratio to the total volume of the sorbic acid used in the specific food product, the sorbic acid of apparently the same volume as the volume obtained by multiplying the predetermined ratio to the total volume of the sorbic acid used in the specific food product, a dummy of apparently the same volume as the volume obtained by multiplying the predetermined ratio to the total volume of the sorbic acid used in the specific food product, aspartame of the same weight as a weight obtained by multiplying a predetermined ratio to a total weight of the aspartame used in the specific food product, a dummy of the same weight as the weight obtained by multiplying the predetermined ratio to the total weight of the aspartame used in the specific food product, the aspartame of the same volume as a volume obtained by multiplying a predetermined ratio to a total volume of the aspartame used in the specific food product, a dummy of the same volume as the volume obtained by multiplying the predetermined ratio to the total volume of the aspartame used in the specific food product, the aspartame of apparently the same volume as the volume obtained by multiplying the predetermined ratio to the total volume of the aspartame used in the specific food product and a dummy of apparently the same volume as the volume obtained by multiplying the predetermined ratio to the total volume of the aspartame used in the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin and an indicating object indicating the predetermined ratio.

[Accessory 59 of Secondary Product]

An object arranged by at least one among a food additive of the same weight as a weight obtained by multiplying a predetermined ratio to a total weight of the food additive used in the specific food product, a dummy of the same weight as the weight obtained by multiplying the predetermined ratio to the total weight of the food additive used in the specific food product, the food additive of the same volume as a volume obtained by multiplying a predetermined ratio to a total volume of the food additive used in the specific food product, a dummy of the same volume as the volume obtained by multiplying the predetermined ratio to the total volume of the food additive used in the specific food product, the food additive of apparently the same volume as the volume obtained by multiplying the predetermined ratio to the total volume of the food additive used in the specific food product, a dummy of apparently the same volume as the volume obtained by multiplying the predetermined ratio to the total volume of the food additive used in the specific food product, sugar of the same weight as a weight obtained by multiplying a predetermined ratio to a total weight of the sugar used in the specific food product, a dummy of the same weight as the weight obtained by multiplying the predetermined ratio to the total weight of the sugar used in the specific food product, the sugar of the same volume as a volume obtained by multiplying a predetermined ratio to a total volume of the sugar used in the specific food product, a dummy of the same volume as the volume obtained by multiplying the predetermined ratio to the total volume of the sugar used in the specific food product, the sugar of apparently the same volume as the volume obtained by multiplying the predetermined ratio to the total volume of the sugar used in the specific food product, a dummy of apparently the same volume as the volume obtained by multiplying the predetermined ratio to the total volume of the sugar used in the specific food product, salt of the same weight as a weight obtained by multiplying a predetermined ratio to a total weight of the salt used in the specific food product, a dummy of the same weight as the weight obtained by multiplying the predetermined ratio to the total weight of the salt used in the specific food product, the salt of the same volume as a volume obtained by multiplying a predetermined ratio to a total volume of the salt used in the specific food product, a dummy of the same volume as the volume obtained by multiplying the predetermined ratio to the total volume of the salt used in the specific food product, the salt of apparently the same volume as the volume obtained by multiplying the predetermined ratio to the total volume of the salt used in the specific food product, a dummy of apparently the same volume as the volume obtained by multiplying the predetermined ratio to the total volume of the salt used in the specific food product, a hydrolyzed protein of the same weight as a weight obtained by multiplying a predetermined ratio to a total weight of the hydrolyzed protein used in the specific food product, a dummy of the same weight as the weight obtained by multiplying the predetermined ratio to the total weight of the hydrolyzed protein used in the specific food product, the hydrolyzed protein of the same volume as a volume obtained by multiplying a predetermined ratio to a total volume of the hydrolyzed protein used in the specific food product, a dummy of the same volume as the volume obtained by multiplying the predetermined ratio to the total volume of the hydrolyzed protein used in the specific food product, the hydrolyzed protein of apparently the same volume as the volume obtained by multiplying the predetermined ratio to the total volume of the hydrolyzed protein used in the specific food product, a dummy of apparently the same volume as the volume obtained by multiplying the predetermined ratio to the total volume of the hydrolyzed protein used in the specific food product, a seasoning of the same weight as a weight obtained by multiplying a predetermined ratio to a total weight of the seasoning used in the specific food product, a dummy of the same weight as the weight obtained by multiplying the predetermined ratio to the total weight of the seasoning used in the specific food product, the seasoning of the same volume as a volume obtained by multiplying a predetermined ratio to a total volume of the seasoning used in the specific food product, a dummy of the same volume as the volume obtained by multiplying the predetermined ratio to the total volume of the seasoning used in the specific food product, the seasoning of apparently the same volume as the volume obtained by multiplying the predetermined ratio to the total volume of the seasoning used in the specific food product, a dummy of apparently the same volume as the volume obtained by multiplying the predetermined ratio to the total volume of the seasoning used in the specific food product, a high-fructose corn syrup of the same weight as a weight obtained by multiplying a predetermined ratio to a total weight of the high-fructose corn syrup used in the specific food product, a dummy of the same weight as the weight obtained by multiplying the predetermined ratio to the total weight of the high-fructose corn syrup used in the specific food product, the high-fructose corn syrup of the same volume as a volume obtained by multiplying a predetermined ratio to a total volume of the high-fructose corn syrup used in the specific food product, a dummy of the same volume as the volume obtained by multiplying the predetermined ratio to the total volume of the high-fructose corn syrup used in the specific food product, the high-fructose corn syrup of apparently the same volume as the volume obtained by multiplying the predetermined ratio to the total volume of the high-fructose corn syrup used in the specific food product, a dummy of apparently the same volume as the volume obtained by multiplying the predetermined ratio to the total volume of the high-fructose corn syrup used in the specific food product, a processed oil or fat of the same weight as a weight obtained by multiplying a predetermined ratio to a total weight of the processed oil or fat used in the specific food product, a dummy of the same weight as the weight obtained by multiplying the predetermined ratio to the total weight of the processed oil or fat used in the specific food product, the processed oil or fat of the same volume as a volume obtained by multiplying a predetermined ratio to a total volume of the processed oil or fat used in the specific food product, a dummy of the same volume as the volume obtained by multiplying the predetermined ratio to the total volume of the processed oil or fat used in the specific food product, the processed oil or fat of apparently the same volume as the volume obtained by multiplying the predetermined ratio to the total volume of the processed oil or fat used in the specific food product, a dummy of apparently the same volume as the volume obtained by multiplying the predetermined ratio to the total volume of the processed oil or fat used in the specific food product, a trans fatty acid of the same weight as a weight obtained by multiplying a predetermined ratio to a total weight of the trans fatty acid used in the specific food product, a dummy of the same weight as the weight obtained by multiplying the predetermined ratio to the total weight of the trans fatty acid used in the specific food product, the trans fatty acid of the same volume as a volume obtained by multiplying a predetermined ratio to a total volume of the trans fatty acid used in the specific food product, a dummy of the same volume as the volume obtained by multiplying the predetermined ratio to the total volume of the trans fatty acid used in the specific food product, the trans fatty acid of apparently the same volume as the volume obtained by multiplying the predetermined ratio to the total volume of the trans fatty acid used in the specific food product, a dummy of apparently the same volume as the volume obtained by multiplying the predetermined ratio to the total volume of the trans fatty acid used in the specific food product, a processed starch of the same weight as a weight obtained by multiplying a predetermined ratio to a total weight of the processed starch used in the specific food product, a dummy of the same weight as the weight obtained by multiplying the predetermined ratio to the total weight of the processed starch used in the specific food product, the processed starch of the same volume as a volume obtained by multiplying a predetermined ratio to a total volume of the processed starch used in the specific food product, a dummy of the same volume as the volume obtained by multiplying the predetermined ratio to the total volume of the processed starch used in the specific food product, the processed starch of apparently the same volume as the volume obtained by multiplying the predetermined ratio to the total volume of the processed starch used in the specific food product, a dummy of apparently the same volume as the volume obtained by multiplying the predetermined ratio to the total volume of the processed starch used in the specific food product, a food additive of the same weight as a weight obtained by multiplying a predetermined ratio to a total weight of the food additive for which, among food additives used in the specific food product, indication of a collective name is allowed, a dummy of the same weight as the weight obtained by multiplying the predetermined ratio to the total weight of the food additive for which, among the food additives used in the specific food product, indication of the collective name is allowed, the food additive of the same volume as a volume obtained by multiplying a predetermined ratio to a total volume of the food additive for which, among the food additives used in the specific food product, indication of the collective name is allowed, a dummy of the same volume as the volume obtained by multiplying the predetermined ratio to the total volume of the food additive for which, among the food additives used in the specific food product, indication of the collective name is allowed, the food additive of apparently the same volume as the volume obtained by multiplying the predetermined ratio to the total volume of the food additive for which, among the food additives used in the specific food product, indication of the collective name is allowed, a dummy of apparently the same volume as the volume obtained by multiplying the predetermined ratio to the total volume of the food additive for which, among the food additives used in the specific food product, indication of the collective name is allowed, a synthetic vitamin of the same weight as a weight obtained by multiplying a predetermined ratio to a total weight of the synthetic vitamin used in the specific food product, a dummy of the same weight as the weight obtained by multiplying the predetermined ratio to the total weight of the synthetic vitamin used in the specific food product, the synthetic vitamin of the same volume as a volume obtained by multiplying a predetermined ratio to a total volume of the synthetic vitamin used in the specific food product, a dummy of the same volume as the volume obtained by multiplying the predetermined ratio to the total volume of the synthetic vitamin used in the specific food product, the synthetic vitamin of apparently the same volume as the volume obtained by multiplying the predetermined ratio to the total volume of the synthetic vitamin used in the specific food product, a dummy of apparently the same volume as the volume obtained by multiplying the predetermined ratio to the total volume of the synthetic vitamin used in the specific food product, a food additive of the same weight as a weight obtained by multiplying a predetermined ratio to a total weight of the food additive that, among food additives used in the specific food product, is deemed to be a carry over, a dummy of the same weight as the weight obtained by multiplying the predetermined ratio to the total weight of the food additive that, among the food additives used in the specific food product, is deemed to be the carry over, the food additive of the same volume as a volume obtained by multiplying a predetermined ratio to a total volume of the food additive that, among the food additives used in the specific food product, is deemed to be the carry over, a dummy of the same volume as the volume obtained by multiplying the predetermined ratio to the total volume of the food additive that, among the food additives used in the specific food product, is deemed to be the carry over, the food additive of apparently the same volume as the volume obtained by multiplying the predetermined ratio to the total volume of the food additive that, among the food additives used in the specific food product, is deemed to be the carry over, a dummy of apparently the same volume as the volume obtained by multiplying the predetermined ratio to the total volume of the food additive that, among the food additives used in the specific food product, is deemed to be the carry over, a food additive of the same weight as a weight obtained by multiplying a predetermined ratio to a total weight of the food additive among food additives used in the specific food product excluding a food additive deemed to be a carry over, a dummy of the same weight as the weight obtained by multiplying the predetermined ratio to the total weight of the food additive among the food additives used in the specific food product excluding the food additive deemed to be the carry over, the food additive of the same volume as a volume obtained by multiplying a predetermined ratio to a total volume of the food additive among the food additives used in the specific food product excluding the food additive deemed to be the carry over, a dummy of the same volume as the volume obtained by multiplying the predetermined ratio to the total volume of the food additive among the food additives used in the specific food product excluding the food additive deemed to be the carry over, the food additive of apparently the same volume as the volume obtained by multiplying the predetermined ratio to the total volume of the food additive among the food additives used in the specific food product excluding the food additive deemed to be the carry over, a dummy of apparently the same volume as the volume obtained by multiplying the predetermined ratio to the total volume of the food additive among the food additives used in the specific food product excluding the food additive deemed to be the carry over, a defatted soybean of the same weight as a weight obtained by multiplying a predetermined ratio to a total weight of the defatted soybean used in the specific food product, a dummy of the same weight as the weight obtained by multiplying the predetermined ratio to the total weight of the defatted soybean used in the specific food product, the defatted soybean of the same volume as a volume obtained by multiplying a predetermined ratio to a total volume of the defatted soybean used in the specific food product, a dummy of the same volume as the volume obtained by multiplying the predetermined ratio to the total volume of the defatted soybean used in the specific food product, the defatted soybean of apparently the same volume as the volume obtained by multiplying the predetermined ratio to the total volume of the defatted soybean used in the specific food product, a dummy of apparently the same volume as the volume obtained by multiplying the predetermined ratio to the total volume of the defatted soybean used in the specific food product, a phosphate of the same weight as a weight obtained by multiplying a predetermined ratio to a total weight of the phosphate used in the specific food product, a dummy of the same weight as the weight obtained by multiplying the predetermined ratio to the total weight of the phosphate used in the specific food product, the phosphate of the same volume as a volume obtained by multiplying a predetermined ratio to a total volume of the phosphate used in the specific food product, a dummy of the same volume as the volume obtained by multiplying the predetermined ratio to the total volume of the phosphate used in the specific food product, the phosphate of apparently the same volume as the volume obtained by multiplying the predetermined ratio to the total volume of the phosphate used in the specific food product, a dummy of apparently the same volume as the volume obtained by multiplying the predetermined ratio to the total volume of the phosphate used in the specific food product, sorbic acid of the same weight as a weight obtained by multiplying a predetermined ratio to a total weight of the sorbic acid used in the specific food product, a dummy of the same weight as the weight obtained by multiplying the predetermined ratio to the total weight of the sorbic acid used in the specific food product, the sorbic acid of the same volume as a volume obtained by multiplying a predetermined ratio to a total volume of the sorbic acid used in the specific food product, a dummy of the same volume as the volume obtained by multiplying the predetermined ratio to the total volume of the sorbic acid used in the specific food product, the sorbic acid of apparently the same volume as the volume obtained by multiplying the predetermined ratio to the total volume of the sorbic acid used in the specific food product, a dummy of apparently the same volume as the volume obtained by multiplying the predetermined ratio to the total volume of the sorbic acid used in the specific food product, aspartame of the same weight as a weight obtained by multiplying a predetermined ratio to a total weight of the aspartame used in the specific food product, a dummy of the same weight as the weight obtained by multiplying the predetermined ratio to the total weight of the aspartame used in the specific food product, the aspartame of the same volume as a volume obtained by multiplying a predetermined ratio to a total volume of the aspartame used in the specific food product, a dummy of the same volume as the volume obtained by multiplying the predetermined ratio to the total volume of the aspartame used in the specific food product, the aspartame of apparently the same volume as the volume obtained by multiplying the predetermined ratio to the total volume of the aspartame used in the specific food product and a dummy of apparently the same volume as the volume obtained by multiplying the predetermined ratio to the total volume of the aspartame used in the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together and an indicating object indicating the predetermined ratio.

[Accessory 60 of Secondary Product]

An object having a seed of a next generation to a raw material of the specific food product or a seed of a next generation to a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 61 of Secondary Product]

An object arranged by a seed of a next generation to a raw material of the specific food product or a seed of a next generation to a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 62 of Secondary Product]

An object having a seed tuber obtained from a portion of a raw material of the specific food product or from a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin.

[Accessory 63 of Secondary Product]

An object arranged by a seed tuber obtained from a portion of a raw material of the specific food product or from a substitutional raw material grown separately of the raw material of the specific food product under substantially the same conditions as the raw material of the specific food product and at least one among a koji, a koji mold, a red koji, a natto bacillus, an Acetobacter, a yeast, a lactic acid bacteria, salt, a soy sauce, a miso, a rice bran, sake lees, a vinegar, a mash, a mustard, and a mirin being contained together.

[Accessory 64 of Secondary Product]

An object arranged by an accessory main body that is a portion of a raw material of the specific food product or is a substitutional raw material grown separately of the raw material of the specific food product under substantially the same conditions as the raw material of the specific food product or is a portion, differing from the raw material of the specific food product, of an integrally grown object grown integrally with the raw material of the specific food product or is a portion, differing from a portion corresponding to the raw material of the specific food product, of a substitutional integrally grown object grown integrally with a substitutional raw material grown separately of the raw material of the specific food product under substantially the same conditions as the raw material of the specific food product being contained together with water.

[Accessory 65 of Secondary Product]

An object arranged by an accessory main body that is a portion of a raw material of the specific food product or is a substitutional raw material grown separately of the raw material of the specific food product under substantially the same conditions as the raw material of the specific food product or is a portion, differing from the raw material of the specific food product, of an integrally grown object grown integrally with the raw material of the specific food product or is a portion, differing from a portion corresponding to the raw material of the specific food product, of a substitutional integrally grown object grown integrally with a substitutional raw material grown separately of the raw material of the specific food product under substantially the same conditions as the raw material of the specific food product being contained together with water and having an ammonia sensor.

[Accessory 66 of Secondary Product]

An agricultural chemical used after harvesting of a raw material of the specific food product.

[Accessory 67 of Secondary Product]

At least one of a fumigant, a disinfectant, a bactericide, an antibacterial agent, a fungicide, an antiseptic, a coating, an antioxidant, a herbicide, an insecticide, a bleach sterilizer, or a chemical agent involved in a raw material of the specific food product after production of the raw material of the specific food product.

[Accessory 68 of Secondary Product]

At least one of a food additive for animal or a growth hormone agent involved in a raw material of the specific food product after production of the raw material of the specific food product.

[Accessory 69 of Secondary Product]

At least one of a fumigant, a disinfectant, a bactericide, an antibacterial agent, a fungicide, an antiseptic, a coating, an antioxidant, a herbicide, an insecticide, a bleach sterilizer, or a chemical agent contained in a raw material of the specific food product immediately before processing of the raw material of the specific food product.

[Accessory 70 of Secondary Product]

At least one among an algae, a grass, and a fishery product grown at substantially the same time and substantially in the same environment as production of a raw material of the specific food product.

Besides the above, if the “specific service” is termite extermination, a box containing a bait for checking the presence of termites (and by which it can be checked that the bait is eaten by termites if there are termites) can be cited as an accessory. Also, if the “specific service” is glass replacement, the same glass as a glass to be mounted can be cited as an accessory.

### Advantages of the Invention

With the product information providing system and the service information providing system according to the present invention, a consumer can select a merchandise or a service with an even higher sense of security and improvement of reliability of a merchandise or a service can be realized.

### BRIEF DESCRIPTION OF THE DRAWINGS

FIG. 1 is a schematic view for describing an arrangement example of a product information providing system according to the present invention;

FIG. 2 is an outline view showing an example of a method for using the product information providing system according to the present invention;

FIG. 3 is a schematic view for describing an arrangement example of a service information providing system according to the present invention;

FIG. 4 is an outline view showing an example of a method for using the service information providing system according to the present invention;

FIG. 5 is an outline view (1) for describing a modification example of the present invention; and

FIG. 6 is an outline view (2) for describing a modification example of the present invention.

### DESCRIPTION OF THE EMBODIMENTS

Modes for implementing the invention (hereinafter referred to as the “embodiments”) shall now be described.

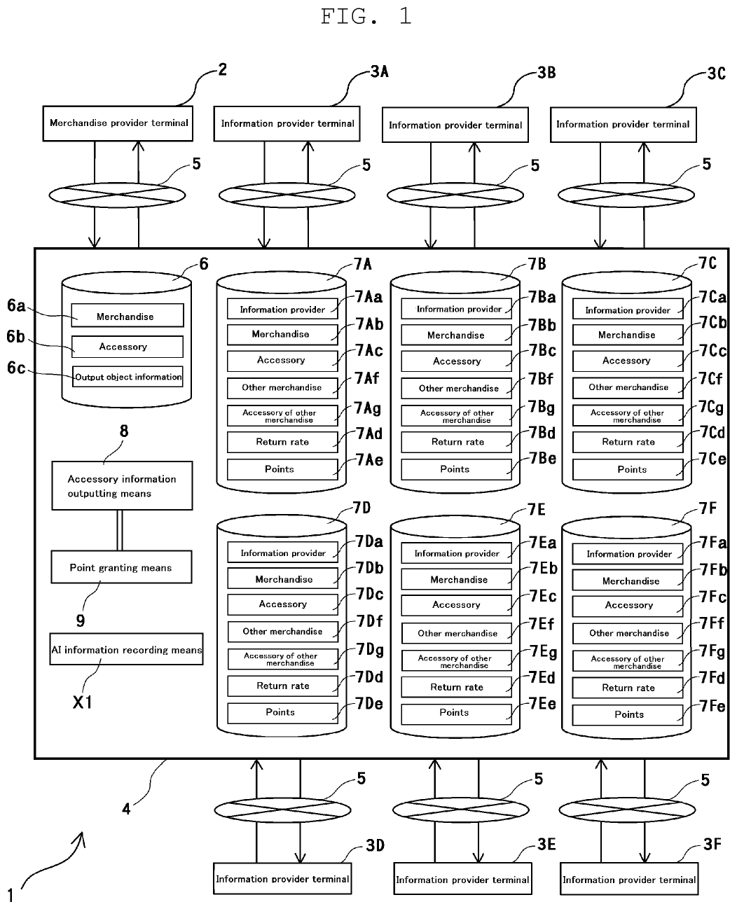

FIG. 1 is a schematic view for describing an arrangement example of a product information providing system according to the present invention. The product information providing system 1 shown in FIG. 1 is constituted of a merchandise provider terminal 2 used by a merchandise provider, information provider terminals 3 (3A, 3B, 3C, 3D, 3E, and 3F) used by information providers, and a server 4. Also, the merchandise provider terminal 2 and the information provider terminals 3 are arranged to be capable of interacting with the server 4 via an internet 5.

Here, the information providers using the information provider terminals 3 are not restricted in particular and include customers (existing customers) who have been provided with a merchandise from the merchandise provider in the past as well as research companies, evaluating companies, etc., the businesses of which are research and evaluation of various merchandises. Also, there may be any of a case where all of the information providers are existing customers, a case where all of the information providers are research companies and evaluating companies, or a case where a portion of the information providers is made up of existing customers and another portion is made up of research companies and evaluating companies.

Also, the server 4 has a merchandise provider information recording means 6 that records merchandise provider information transmitted from the merchandise provider terminal 2.

Further, the merchandise provider information recording means 6 is arranged to be capable of recording at least information 6a on a content of a merchandise that the merchandise provider provides to a customer, information 6b on an accessory provided together with such merchandise, and output object information 6c for specifying information provider information that is output.

Here, the information 6b on the accessory and the output object information 6c are recorded in association with the information 6a on the content of the merchandise. In addition, if a plurality of information on contents of merchandises are recorded (that is, if information on a content of a merchandise other than that of the information 6a on the content of the merchandise is also recorded in addition to the information 6a on the content of the merchandise), information on an accessory and output object information corresponding to the information on each merchandise are recorded.

Also, the server 4 has an information provider information recording means 7A that records information provider information A transmitted from the information provider terminal 3A used by an information provider, an information provider information recording means 7B that records information provider information B transmitted from the information provider terminal 3B used by an information provider, an information provider information recording means 7C that records information provider information C transmitted from the information provider terminal 3C used by an information provider, an information provider information recording means 7D that records information provider information D transmitted from the information provider terminal 3D used by an information provider, an information provider information recording means 7E that records information provider information E transmitted from the information provider terminal 3E used by an information provider, and an information provider information recording means 7F that records information provider information F transmitted from the information provider terminal 3F used by an information provider.

Also, the information provider information recording means 7A is arranged to be capable of recording at least information 7Aa on the information provider who uses the information provider terminal 3A, information 7Ab on a content of a merchandise provided from a merchandise provider, information 7Ac on an accessory provided from the merchandise provider, information 7Ad on a return rate when the information 7Ac on the accessory is used, and information 7Ae on points held.

Further, the information provider information recording means 7A is arranged to be capable of recording information 7Af on a content of another merchandise of the same type and same category as the merchandise provided from the merchandise provider and information 7Ag on an accessory of the other merchandise provided from a merchandise provider of the other merchandise.

Here, the information 7Ab on the content of the merchandise, the information 7Ac on the accessory, the information 7Ad on the return rate, the information 7Ae on the points, the information 7Af on the content of the other merchandise, and the information 7Ag on the accessory of the other merchandise are recorded in association with the information 7Aa on the information provider. Also, the information 7Ac on the accessory, the information 7Ad on the return rate, the information 7Af on the content of the other merchandise, and the information 7Ag on the accessory of the other merchandise are recorded in association with the information 7Ab on the content of the merchandise. In addition, if a plurality of information on contents of merchandises are recorded (that is, if information on a content of a merchandise other than that of the information 7Ab on the content of the merchandise is also recorded in addition to the information 7Ab on the content of the merchandise), information on an accessory, a return rate, information on a content of another merchandise, and information on an accessory of the other merchandise corresponding to the information on the content of each merchandise are recorded.

Similarly, the information provider information recording means 7B is arranged to be capable of recording at least information 7Ba on the information provider who uses the information provider terminal 3B, information 7Bb on a content of a merchandise provided from a merchandise provider, information 7Bc on an accessory provided from the merchandise provider, information 7Bd on a return rate in a case where the information 7Bc on the accessory is used, and information 7Be on points held.

Further, the information provider information recording means 7B is arranged to be capable of recording information 7Bf on a content of another merchandise of the same type and same category as the merchandise provided from the merchandise provider and information 7Bg on an accessory of the other merchandise provided from a merchandise provider of the other merchandise.

Here, the information 7Bb on the content of the merchandise, the information 7Bc on the accessory, the information 7Bd on the return rate, the information 7Be on the points, the information 7Bf on the content of the other merchandise, and the information 7Bg on the accessory of the other merchandise are recorded in association with the information 7Ba on the information provider. Also, the information 7Bc on the accessory, the information 7Bd on the return rate, the information 7Bf on the content of the other merchandise, and the information 7Bg on the accessory of the other merchandise are recorded in association with the information 7Bb on the content of the merchandise. In addition, if a plurality of information on contents of merchandises are recorded (that is, if information on a content of a merchandise other than that of the information 7Bb on the content of the merchandise is also recorded in addition to the information 7Bb on the content of the merchandise), information on an accessory, a return rate, information on a content of another merchandise, and information on an accessory of the other merchandise corresponding to the information on the content of each merchandise are recorded.

Similarly, the information provider information recording means 7C is arranged to be capable of recording at least information 7Ca on the information provider who uses the information provider terminal 3C, information 7Cb on a content of a merchandise provided from a merchandise provider, information 7Cc on an accessory provided from the merchandise provider, information 7Cd on a return rate in a case where the information 7Cc on the accessory is used, and information 7Ce on points held.

Further, the information provider information recording means 7C is arranged to be capable of recording information 7Cf on a content of another merchandise of the same type and same category as the merchandise provided from the merchandise provider and information 7Cg on an accessory of the other merchandise provided from a merchandise provider of the other merchandise.

Here, the information 7Cb on the content of the merchandise, the information 7Cc on the accessory, the information 7Cd on the return rate, the information 7Ce on the points, the information 7Cf on the content of the other merchandise, and the information 7Cg on the accessory of the other merchandise are recorded in association with the information 7Ca on the information provider. Also, the information 7Cc on the accessory, the information 7Cd on the return rate, the information 7Cf on the content of the other merchandise, and the information 7Cg on the accessory of the other merchandise are recorded in association with the information 7Cb on the content of the merchandise. In addition, if a plurality of information on contents of merchandises are recorded (that is, if information on a content of a merchandise other than that of the information 7Cb on the content of the merchandise is also recorded in addition to the information 7Cb on the content of the merchandise), information on an accessory, a return rate, information on a content of another merchandise, and information on an accessory of the other merchandise corresponding to the information on the content of each merchandise are recorded.

Similarly, the information provider information recording means 7D is arranged to be capable of recording at least information 7Da on the information provider who uses the information provider terminal 3D, information 7Db on a content of a merchandise provided from a merchandise provider, information 7Dc on an accessory provided from the merchandise provider, information 7Dd on a return rate in a case where the information 7Dc on the accessory is used, and information 7De on points held.

Further, the information provider information recording means 7D is arranged to be capable of recording information 7Df on a content of another merchandise of the same type and same category as the merchandise provided from the merchandise provider and information 7Dg on an accessory of the other merchandise provided from a merchandise provider of the other merchandise.

Here, the information 7Db on the content of the merchandise, the information 7Dc on the accessory, the information 7Dd on the return rate, the information 7De on the points, the information 7Df on the content of the other merchandise, and the information 7Dg on the accessory of the other merchandise are recorded in association with the information 7Da on the information provider. Also, the information 7Dc on the accessory, the information 7Dd on the return rate, the information 7Df on the content of the other merchandise, and the information 7Dg on the accessory of the other merchandise are recorded in association with the information 7Db on the content of the merchandise. In addition, if a plurality of information on contents of merchandises are recorded (that is, if information on a content of a merchandise other than that of the information 7Db on the content of the merchandise is also recorded in addition to the information 7Db on the content of the merchandise), information on an accessory, a return rate, information on a content of another merchandise, and information on an accessory of the other merchandise corresponding to the information on the content of each merchandise are recorded.

Similarly, the information provider information recording means 7E is arranged to be capable of recording at least information 7Ea on the information provider who uses the information provider terminal 3E, information 7Eb on a content of a merchandise provided from a merchandise provider, information 7Ec on an accessory provided from the merchandise provider, information 7Ed on a return rate in a case where the information 7Ec on the accessory is used, and information 7Ee on points held.

Further, the information provider information recording means 7E is arranged to be capable of recording information 7Ef on a content of another merchandise of the same type and same category as the merchandise provided from the merchandise provider and information 7Eg on an accessory of the other merchandise provided from a merchandise provider of the other merchandise.

Here, the information 7Eb on the content of the merchandise, the information 7Ec on the accessory, the information 7Ed on the return rate, the information 7Ee on the points, the information 7Ef on the content of the other merchandise, and the information 7Eg on the accessory of the other merchandise are recorded in association with the information 7Ea on the information provider. Also, the information 7Ec on the accessory, the information 7Ed on the return rate, the information 7Ef on the content of the other merchandise, and the information 7Eg on the accessory of the other merchandise are recorded in association with the information 7Eb on the content of the merchandise. In addition, if a plurality of information on contents of merchandises are recorded (that is, if information on a content of a merchandise other than that of the information 7Eb on the content of the merchandise is also recorded in addition to the information 7Eb on the content of the merchandise), information on an accessory, a return rate, information on a content of another merchandise, and information on an accessory of the other merchandise corresponding to the information on the content of each merchandise are recorded.

Similarly, the information provider information recording means 7F is arranged to be capable of recording at least information 7Fa on the information provider who uses the information provider terminal 3F, information 7Fb on a content of a merchandise provided from a merchandise provider, information 7Fc on an accessory provided from the merchandise provider, information 7Fd on a return rate in a case where the information 7Fc on the accessory is used, and information 7Fe on points held.

Further, the information provider information recording means 7F is arranged to be capable of recording information 7Ff on a content of another merchandise of the same type and same category as the merchandise provided from the merchandise provider and information 7Fg on an accessory of the other merchandise provided from a merchandise provider of the other merchandise.

Here, the information 7Fb on the content of the merchandise, the information 7Fc on the accessory, the information 7Fd on the return rate, the information 7Fe on the points, the information 7Ff on the content of the other merchandise, and the information 7Fg on the accessory of the other merchandise are recorded in association with the information 7Fa on the information provider. Also, the information 7Fc on the accessory, the information 7Fd on the return rate, the information 7Ff on the content of the other merchandise, and the information 7Fg on the accessory of the other merchandise are recorded in association with the information 7Fb on the content of the merchandise. In addition, if a plurality of information on contents of merchandises are recorded (that is, if information on a content of a merchandise other than that of the information 7Fb on the content of the merchandise is also recorded in addition to the information 7Fb on the content of the merchandise), information on an accessory, a return rate, information on a content of another merchandise, and information on an accessory of the other merchandise corresponding to the information on the content of each merchandise are recorded.

Also, the server 4 has an accessory information outputting means 8 that, when a new customer (potential customer) requests for information, outputs, based on information recorded in the output object information 6c, information on an accessory, information on a content of another merchandise, and information on an accessory of the other merchandise recorded in the information provider information recording means 7. Specifically, if, for example, the “information 7Ec on the accessory” is recorded as an output object in the output object information 6c, the information 7Ec on the accessory, the information 7Ef on the content of the other merchandise, and the information 7Eg on the accessory of the other merchandise are output.

Further, the server 4 has an AI information recording means X1 in which specific information collected from various databases by artificial intelligence (AI) based on the merchandise provider information recorded in the merchandise provider information recording means 6 and the information provider information recorded in the information provider information recording means 7 is recorded. Here, the “specific information” is, for example, information related to a quality of a merchandise provided by a merchandise provider, etc., and is not restricted in particular.

Incidentally, if it is made possible for information provider information to be changed by just a judgment of an information provider, a merchandise provider may be put at a great disadvantage depending on a content of the information after the change. As such a case, that in which a content is made desirable to the merchandise provider in a new recording to make the merchandise provider select it and thereafter changed to false information with ill intent, etc., can be cited as an example. Therefore, in regard to a change of information provider information, an arrangement may be made such that the information provider can make it on his/her own but the change is reflected only when the content of the change is approved by the merchandise provider. In addition, in a case of a new recording (and not a change of recorded information), an arrangement for approval, etc., is unnecessary because information is not output unless the merchandise provider selects it.

Further, the server 4 has a point granting means 9 that grants points to an information provider when the accessory information outputting means 9 outputs information on an accessory, etc. Specifically, for example, if the information 7Ec on the accessory, the information 7Ef on the content of the other merchandise, and the information 7Eg on the accessory of the other merchandise are output, points in accordance with the information 7Ed on the return rate are added to the information 7Ee on the points held in the information provider information recording means 7E.

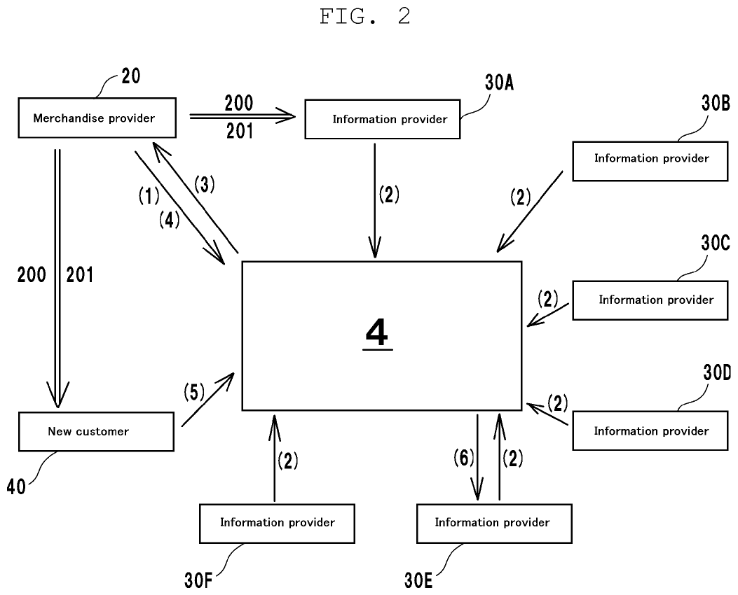

FIG. 2 is an outline view showing an example of a method for using the product information providing system according to the present invention. In the following, a description shall be provided on a premise that each of information providers 30 (30A, 30B, 30C, 30D, 30E, and 30F) has been provided with a merchandise from a merchandise provider 20 in the past and a new customer 40 performs collection of information in examining whether or not to be provided with a merchandise from the merchandise provider 20.

[1. Recording of Various Information]

In the example of the method for using the product information providing system according to the present invention, various information must be recorded in the server 4 for the new customer 40 to obtain information. Recording of the various information into the server 4 shall thus be described.

First, the merchandise provider 20 uses the merchandise provider terminal 2 to record a content of a merchandise that confidence provides (the information 6a on the content of the merchandise) in the merchandise provider information recording means 6. Also, the merchandise provider 20 uses the merchandise provider terminal 2 to record a content of an accessory that confidence provides (the information 6b on the accessory) in the merchandise provider information recording means 6. These recordings correspond to a step indicated by a symbol (1) in FIG. 2.

Next, the merchandise provider 20 provides a merchandise 200 to the information provider 30A. Also, the merchandise provider 20 provides an actual accessory 201 together with the merchandise 200 to the information provider 30A. Here, the accessory 201 is provided for understanding of quality (in other words, visualization of quality) of the merchandise 200.

That is, the merchandise provider 20 provides the actual accessory 201 to the information provider 30A together with providing the merchandise 200 such that the information provider 30A can sufficiently ascertain the quality of the merchandise 200.

Subsequently, the information provider 30A uses the information provider terminal 3A to record information specifying him/herself (the information 7Aa on the information provider) in the information provider information recording means 7A. Also, a content of the merchandise 200 provided from the merchandise provider 20 (the information 7Ab on the content of the merchandise) and a content of the accessory 201 provided from the merchandise provider 20 (the information 7Ac on the accessory) are recorded in association with the information 7Aa on the information provider in the information provider information recording means 7A using the information provider terminal 3A.

Also, a content of another merchandise of the same type and same category as the merchandise 200 (the information 7Af on the content of the other merchandise) and a content of an accessory provided from a provider of the other merchandise when the other merchandise is provided (the information 7Ag on the accessory of the other merchandise) are recorded in association with the information 7Aa on the information provider in the information provider information recording means 7A using the information provider terminal 3A.

Here, the other merchandise (the merchandise of the same type and same category as the merchandise 200) may be that provided by the merchandise provider 20 or may be that provided by a merchandise provider differing from the merchandise provider 20.

Further, the information 7Ad on the return rate when the information 7Ac on the accessory, the information 7Af on the content of the other merchandise, and the information 7Ag on the accessory of the other merchandise are used is recorded in association with the information 7Aa on the information provider in the information provider information recording means 7A using the information provider terminal 3A. These recordings correspond to a step indicated by a symbol (2) in FIG. 2.

Also, the information provider 30A may record various information that enable the quality of the merchandise 200 to be ascertained. For example, actual conditions and policy of business, actual conditions of organization, actual conditions of transactions, etc., of the merchandise provider 20 can be cited. By the information provider 30A recording information that could only have been obtained by actually transacting with the merchandise provider 20, visualization of the reality of the merchandise provider 20 is made possible.

In addition, when the information provider 30A records the various information, a “statement to that effect” is transmitted to the merchandise provider 20 (step indicated by a symbol (3) in FIG. 2).

Although a case where the information provider 30A records the information 7Aa on the information provider, the information 7Ab on the content of the merchandise, the information 7Ac on the accessory, the information 7Ad on the return rate, the information 7Af on the content of the other merchandise, and the information 7Ag on the accessory of the other merchandise is described here, the information provider 30B, the information provider 30C, the information provider 30D, the information provider 30E, and the information provider 30F also perform recordings similarly. Here, the recordings are not meant to be performed by the information providers 30A to 30F at the same timing but are performed successively after receipt of the merchandise from the merchandise provider 20.

Next, as a consequence of the “statement to that effect” being transmitted in the step indicated by (3), the merchandise provider 20 accesses the server 4 and upon checking the recorded information provider information 30 (30A to 30F), selects one of the information provider information (for example, selects the information provider information by comparing the quality of the information on the accessory or selects the information provider information by comparing the return rate, etc.) and uses the merchandise provider terminal 2 to record the output object information 6c (step indicated by a symbol (4) in FIG. 2).

After the recording of the various information such as those described above, it becomes possible to provide the various information to the new customer 40.

In addition, although just a case where the information providers 30 perform the recordings of the various information in regard to the merchandise 200 provided by the merchandise provider 20 is described here, the information recorded in the server 4 is not just that related to the “merchandise 200 provided by the merchandise provider 20” but those related to a “merchandise provided by the merchandise provider 20 other than the merchandise 200” and a “merchandise provided by a merchandise provider other than the merchandise provider 20” are also recorded. That is, although with the present embodiment, a case where the new customer 40 obtains information related to the merchandise 200 provided by the merchandise provider 20 is described as an example (below), the server 4 can also provide information related to a “merchandise provided by the merchandise provider 20 other than the merchandise 200” and a “merchandise provided by a merchandise provider other than the merchandise provider 20.”

[2. Providing of Various Information]

The new customer 40 who desires to be provided with various information in relation to the merchandise 200 provided by the merchandise provider 20 accesses the server 4 via the internet 5 by a new customer terminal (not shown) (step indicated by a symbol (5) in FIG. 2).

When the server 4 is accessed, a list of merchandise providers capable of providing information is displayed on the new customer terminal and the new customer 40 selects the “merchandise provider 20” from within the displayed list. Also, when the “merchandise provider 20” is selected, a list of merchandises provided by the merchandise provider 20 is displayed, and the new customer 40 selects the “merchandise 200” from within the displayed list.

Then, when the “merchandise 200 of the merchandise provider 20” is selected from the new customer terminal, the accessory information outputting means 8 outputs the information 6a on the content of the merchandise recorded in the merchandise provider information recording means 6 (the information corresponding to the merchandise 200 is the information 6a on the content of the merchandise) and the information 6b on the accessory associated with the information 6a on the content of the merchandise (the information is displayed on the new customer terminal).

Together with the above, the accessory information outputting means 8 outputs information provider information based on the output object information 6c associated with the information 6a on the content of the merchandise (the information is displayed on the new customer terminal). Specifically, if, for example, the “information 7Ec on the accessory” is recorded as an output object in the output object information 6c, the information 7Ec on the accessory, the information 7Eb on the content of the merchandise associated with the information 7Ec on the accessory, the information 7Ef on the content of the other merchandise, and the information 7Eg on the accessory of the other merchandise are output.

Also, information recorded in the AI information recording means X1 is output to the new customer 40 accessing the server 4 (the information is displayed on the new customer terminal).

Thereafter, if the new customer 40 is to be provided with the merchandise 200 of the merchandise provider 20 (if the merchandise 200 of the merchandise provider 20 is to be purchased), the merchandise provider 20 provides the merchandise 200 to the new customer 40. Also, the merchandise provider 20 provides the actual accessory 201 together with the merchandise 200 to the new customer 40.

In addition, when the accessory information outputting means 8 outputs the information, a “statement to that effect” is transmitted to an information provider (step indicated by a symbol (6) in FIG. 2 in a case of transmission to the information provider 7E).

[3. Granting of Points]

When the accessory information outputting means 8 outputs the information, the point granting means 9 grants points to a party that registered the information output by the accessory information outputting means 8. Specifically, for example, if the accessory information outputting means 8 outputs the information 7Ec on the accessory, points corresponding to a price obtained by multiplying a “price of the merchandise 200 of the merchandise provider 20” by the information 7Ed on the return rate are granted and the information 7Ee on the points held becomes renewed.

[Effect(s)]

With the product information providing system according to the present invention described above, the quality of the merchandise 200 of the merchandise provider 20 can be ascertained by the information 7Ec on the accessory. Further, by the information 7Ef on the content of the other merchandise and the information 7Eg on the accessory of the other merchandise, the merchandise 200 can be compared with the other merchandise to ascertain the quality. In addition, before being provided with the merchandise 200, the quality of the merchandise 200 can be ascertained by checking the information 7Ec on the accessory, etc., and therefore, the new customer 40 can obtain a material for judging whether or not to receive the merchandise 200 of the merchandise provider 20 (whether or not to purchase the merchandise 200).

Also, by both the information 6b on the accessory and the information 7Ec on the accessory being output and by specifying the accessory 201 based on the information of both the party providing the merchandise (merchandise provider 20) and the party provided with the merchandise (information provider 30E), alteration or forgery, etc., of information can be suppressed.

Similarly, by both the information 6a on the content of the merchandise and the information 7Eb on the content of the merchandise being output and by specifying the merchandise 200 based on the information of both the party providing the merchandise (merchandise provider 20) and the party provided with the merchandise (information provider 30E), alteration or forgery, etc., of information can be suppressed.

Also, by points being granted to the information providers, enhancement of each information provider's wish to register information provider information and improvement of information provider information (improvement of numerical quantity and improvement of quality) can be anticipated and consequently, it is made possible to ascertain the quality of the merchandise 200 even more through the accessory.

Also, due to each information provider being able to register the information on the accessory and the information on the return rate on his/her own and points being granted for just the information provider information selected by the merchandise provider 20, improvement of the quality of the information provider information can be anticipated, and even by this aspect, it is made possible to ascertain the quality of the merchandise 200 even more through the accessory.

### MODIFICATION EXAMPLE 1

Although with the example of the merchandise information providing system according to the present invention described above, a case where the information 7Ec on the accessory is output is described as an example, since it suffices that the new customer 40 be able to check the information on the accessory, identification information (an identifier such as a two-dimensional barcode, a color code, etc.) that enables access to the information 7Ec on the accessory may be output instead. In this case, the identification information is used to access, by the new customer terminal, a website, etc., on which the information 7Ec on the accessory is posted to check the information 7Ec on the accessory.

Here, in a case where the information 7Ec on the accessory is to be accessed through identification information as in Modification Example 1, even when the information 7Ec on the accessory in the information provider information recording means 7E is changed, an arrangement may be made, in consideration of a new customer's anticipation that the same information would be posted in the accessed website, such that the information 7Ec on the accessory before the change is posted in the website accessed by the identification information output before the change.

### MODIFICATION EXAMPLE 2

Also, although with the example of the product information providing system according to the present invention described above, a case where the accessory 201 is provided together with the specific merchandise 200 is described as an example, the accessory 201 does not have to be provided necessarily and just the merchandise 200 may be provided from the merchandise provider 20.

### MODIFICATION EXAMPLE 3

Further, although with the example of the product information providing system according to the present invention described above, the information (7Ac, 7Bc, 7Cc, 7Dc, 7Ec, and 7Fc) on the accessory in the information provider information is described with the “information on the accessory 201 provided by the merchandise provider 20” as an example thereof and a case where it is of the same type as the information 6b on the accessory (that is, the information on the accessory in the information provider information and the information on the accessory 6b have the point in common of being information relating to the accessory 201) is described as an example, the information on the accessory in the information provider information is not required to be of the same type as the information on the accessory 6b and may be any information as long as it is information for understanding of quality of the specific merchandise 200.

### MODIFICATION EXAMPLE 4

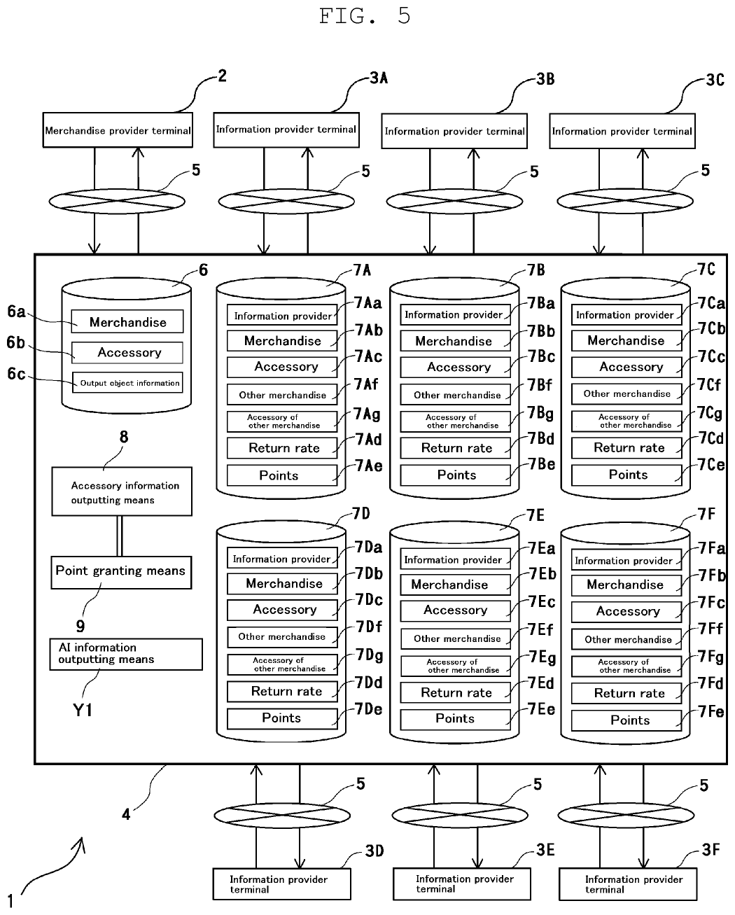

Also, in place of the AI information recording means X1 in the example of the product information providing system according to the present invention described above, the system may have an AI information outputting means Y1 that provides, to the new customer 40 accessing the server 4, specific information collected from various databases by artificial intelligence (AI) (in other words, displays the specific information collected from various databases by AI on the new customer terminal) based on the merchandise provider information recorded in the merchandise provider information recording means 6 and the information provider information recorded in the information provider information recording means 7 (see FIG. 5).

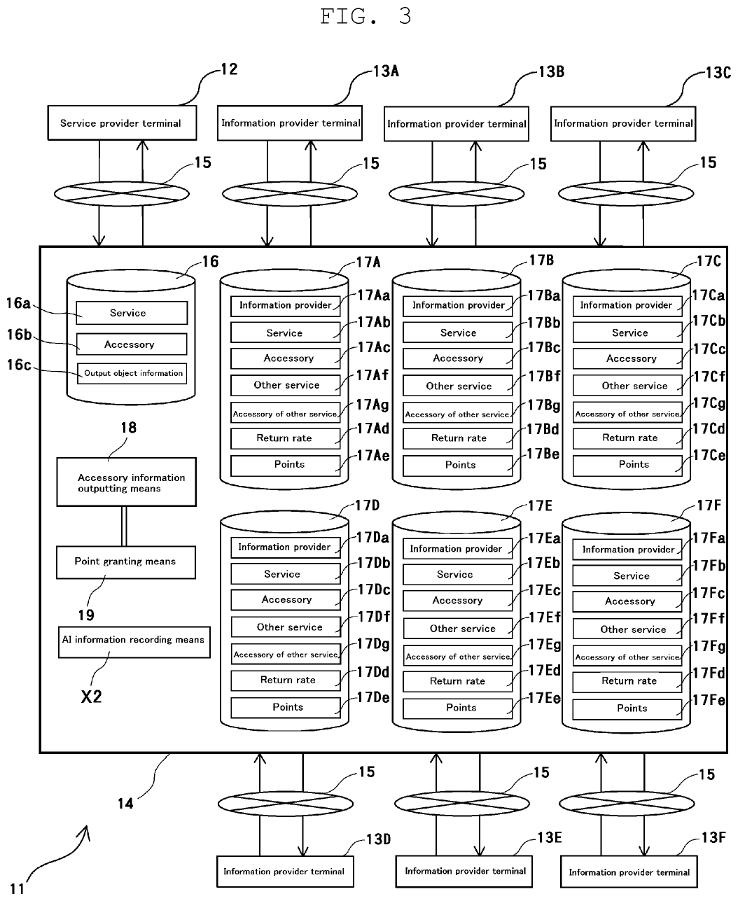

FIG. 3 is a schematic view for describing an arrangement example of a service information providing system according to the present invention. The service information providing system 11 shown in FIG. 3 is constituted of a service provider terminal 12 used by a service provider, information provider terminals 13 (13A, 13B, 13C, 13D, 13E, and 13F) used by information providers, and a server 14. Also, the service provider terminal 12 and the information provider terminals 13 are arranged to be capable of interacting with the server 14 via an internet 15.

Here, the information providers using the information provider terminals 13 are not restricted in particular and include customers (existing customers) who have been provided with a service from the service provider in the past as well as research companies, evaluating companies, etc., the businesses of which are research and evaluation of various services. Also, there may be any of a case where all of the information providers are existing customers, a case where all of the information providers are research companies and evaluating companies, or a case where a portion of the information providers is made up of existing customers and another portion is made up of research companies and evaluating companies.

Also, the server 14 has a service provider information recording means 16 that records service provider information transmitted from the service provider terminal 12.

Further, the service provider information recording means 16 is arranged to be capable of recording at least information 16a on a content of a service that the service provider provides to a customer, information 16b on an accessory that is a contract content (also including a price of the service) exchanged in being provided with such service, and output object information 16c for specifying information provider information that is output.

Here, the information 16b on the accessory and the output object information 16c are recorded in association with the information 16a on the content of the service. In addition, if a plurality of information on contents of services are recorded (that is, if information on a content of a service other than that of the information 16a on the content of the service is also recorded in addition to the information 16a on the content of the service), information on an accessory and output object information corresponding to the information on a content of each service are recorded.

Also, the server 14 has an information provider information recording means 17A that records information provider information A transmitted from the information provider terminal 13A used by an information provider, an information provider information recording means 17B that records information provider information B transmitted from the information provider terminal 13B used by an information provider, an information provider information recording means 17C that records information provider information C transmitted from the information provider terminal 13C used by an information provider, an information provider information recording means 17D that records information provider information D transmitted from the information provider terminal 13D used by an information provider, an information provider information recording means 17E that records information provider information E transmitted from the information provider terminal 13E used by an information provider, and an information provider information recording means 17F that records information provider information F transmitted from the information provider terminal 13F used by an information provider.

Also, the information provider information recording means 17A is arranged to be capable of recording at least information 17Aa on the information provider who uses the information provider terminal 13A, information 17Ab on a content of a service provided from a service provider, information 17Ac on an accessory that is a contract content (including a price of the service) exchanged in receiving the service provided from the service provider, information 17Ad on a return rate when the information 17Ac on the accessory is used, and information 17Ae on points held.

Further, the information provider information recording means 17A is arranged to be capable of recording information 17Af on a content of another service of the same type and same category as the service provided from the service provider and information 17Ag on an accessory of the other service that is a contract content (including a price of the other service) exchanged in receiving the other service.

Here, the information 17Ab on the content of the service, the information 17Ac on the accessory, the information 17Ad on the return rate, the information 17Ae on the points, the information 17Af on the content of the other service, and the information 17Ag on the accessory of the other service are recorded in association with the information 17Aa on the information provider. Also, the information 17Ac on the accessory, the information 17Ad on the return rate, the information 17Af on the content of the other service, and the information 17Ag on the accessory of the other service are recorded in association with the information 17Ab on the content of the service. In addition, if a plurality of information on contents of services are recorded (that is, if information on a content of a service other than that of the information 17Ab on the content of the service is also recorded in addition to the information 17Ab on the content of the service), information on an accessory, information on a return rate, information on a content of another service, and information on an accessory of the other service corresponding to the information on the content of each service are recorded.

Similarly, the information provider information recording means 17B is arranged to be capable of recording at least information 17Ba on the information provider who uses the information provider terminal 13B, information 17Bb on a content of a service provided from a service provider, information 17Bc on an accessory that is a contract content (including a price of the service) exchanged in receiving the service provided from the service provider, information 17Bd on a return rate in a case where the information 17Bc on the accessory is used, and information 17Be on points held.

Further, the information provider information recording means 17B is arranged to be capable of recording information 17Bf on a content of another service of the same type and same category as the service provided from the service provider and information 17Bg on an accessory of the other service that is a contract content (including a price of the other service) exchanged in receiving the other service.

Here, the information 17Bb on the content of the service, the information 17Bc on the accessory, the information 17Bd on the return rate, the information 17Be on the points, the information 17Bf on the content of the other service, and the information 17Bg on the accessory of the other service are recorded in association with the information 17Ba on the information provider. Also, the information 17Bc on the accessory, the information 17Bd on the return rate, the information 17Bf on the content of the other service, and the information 17Bg on the accessory of the other service are recorded in association with the information 17Bb on the content of the service. In addition, if a plurality of information on contents of services are recorded (that is, if information on a content of a service other than that of the information 17Bb on the content of the service is also recorded in addition to the information 17Bb on the content of the service), information on an accessory, information on a return rate, information on a content of another service, and information on an accessory of the other service corresponding to the information on the content of each service are recorded.

Similarly, the information provider information recording means 17C is arranged to be capable of recording at least information 17Ca on the information provider who uses the information provider terminal 13C, information 17Cb on a content of a service provided from a service provider, information 17Cc on an accessory that is a contract content (including a price of the service) exchanged in receiving the service provided from the service provider, information 17Cd on a return rate in a case where the information 17Cc on the accessory is used, and information 17Ce on points held.

Further, the information provider information recording means 17C is arranged to be capable of recording information 17Cf on a content of another service of the same type and same category as the service provided from the service provider and information 17Cg on an accessory of the other service that is a contract content (including a price of the other service) exchanged in receiving the other service.

Here, the information 17Cb on the content of the service, the information 17Cc on the accessory, the information 17Cd on the return rate, the information 17Ce on the points, the information 17Cf on the content of the other service, and the information 17Cg on the accessory of the other service are recorded in association with the information 17Ca on the information provider. Also, the information 17Cc on the accessory, the information 17Cd on the return rate, the information 17Cf on the content of the other service, and the information 17Cg on the accessory of the other service are recorded in association with the information 17Cb on the content of the service. In addition, if a plurality of information on contents of services are recorded (that is, if information on a content of a service other than that of the information 17Cb on the content of the service is also recorded in addition to the information 17Cb on the content of the service), information on an accessory, information on a return rate, information on a content of another service, and information on an accessory of the other service corresponding to the information on the content of each service are recorded.

Similarly, the information provider information recording means 17D is arranged to be capable of recording at least information 17Da on the information provider who uses the information provider terminal 13D, information 17Db on a content of a service provided from a service provider, information 17Dc on an accessory that is a contract content (including a price of the service) exchanged in receiving the service provided from the service provider, information 17Dd on a return rate in a case where the information 17Dc on the accessory is used, and information 17De on points held.

Further, the information provider information recording means 17D is arranged to be capable of recording information 17Df on a content of another service of the same type and same category as the service provided from the service provider and information 17Dg on an accessory of the other service that is a contract content (including a price of the other service) exchanged in receiving the other service.

Here, the information 17Db on the content of the service, the information 17Dc on the accessory, the information 17Dd on the return rate, the information 17De on the points, the information 17Df on the content of the other service, and the information 17Dg on the accessory of the other service are recorded in association with the information 17Da on the information provider. Also, the information 17Dc on the accessory, the information 17Dd on the return rate, the information 17Df on the content of the other service, and the information 17Dg on the accessory of the other service are recorded in association with the information 17Db on the content of the service. In addition, if a plurality of information on contents of services are recorded (that is, if information on a content of a service other than that of the information 17Db on the content of the service is also recorded in addition to the information 17Db on the content of the service), information on an accessory, information on a return rate, information on a content of another service, and information on an accessory of the other service corresponding to the information on the content of each service are recorded.

Similarly, the information provider information recording means 17E is arranged to be capable of recording at least information 17Ea on the information provider who uses the information provider terminal 13E, information 17Eb on a content of a service provided from a service provider, information 17Ec on an accessory that is a contract content (including a price of the service) exchanged in receiving the service provided from the service provider, information 17Ed on a return rate in a case where the information 17Ec on the accessory is used, and information 17Ee on points held.

Further, the information provider information recording means 17E is arranged to be capable of recording information 17Ef on a content of another service of the same type and same category as the service provided from the service provider and information 17Eg on an accessory of the other service that is a contract content (including a price of the other service) exchanged in receiving the other service.

Here, the information 17Eb on the content of the service, the information 17Ec on the accessory, the information 17Ed on the return rate, the information 17Ee on the points, the information 17Ef on the content of the other service, and the information 17Eg on the accessory of the other service are recorded in association with the information 17Ea on the information provider. Also, the information 17Ec on the accessory, the information 17Ed on the return rate, the information 17Ef on the content of the other service, and the information 17Eg on the accessory of the other service are recorded in association with the information 17Eb on the content of the service. In addition, if a plurality of information on contents of services are recorded (that is, if information on a content of a service other than that of the information 17Eb on the content of the service is also recorded in addition to the information 17Eb on the content of the service), information on an accessory, information on a return rate, information on a content of another service, and information on an accessory of the other service corresponding to the information on the content of each service are recorded.

Similarly, the information provider information recording means 17F is arranged to be capable of recording at least information 17Fa on the information provider who uses the information provider terminal 13F, information 17Fb on a content of a service provided from a service provider, information 17Fc on an accessory that is a contract content (including a price of the service) exchanged in receiving the service provided from the service provider, information 17Fd on a return rate in a case where the information 17Fc on the accessory is used, and information 17Fe on points held.

Further, the information provider information recording means 17F is arranged to be capable of recording information 17Ff on a content of another service of the same type and same category as the service provided from the service provider and information 17Fg on an accessory of the other service that is a contract content (including a price of the other service) exchanged in receiving the other service.

Here, the information 17Fb on the content of the service, the information 17Fc on the accessory, the information 17Fd on the return rate, the information 17Fe on the points, the information 17Ff on the content of the other service, and the information 17Fg on the accessory of the other service are recorded in association with the information 17Fa on the information provider. Also, the information 17Fc on the accessory, the information 17Fd on the return rate, the information 17Ff on the content of the other service, and the information 17Fg on the accessory of the other service are recorded in association with the information 17Fb on the content of the service. In addition, if a plurality of information on contents of services are recorded (that is, if information on a content of a service other than that of the information 17Fb on the content of the service is also recorded in addition to the information 17Fb on the content of the service), information on an accessory, information on a return rate, information on a content of another service, and information on an accessory of the other service corresponding to the information on the content of each service are recorded.

Also, the server 14 has an accessory information outputting means 18 that, when a new customer (potential customer) requests for information, outputs, based on information recorded in the output object information 16c, information on an accessory, information on a content of another service, and information on an accessory of the other service recorded in the information provider information recording means 17. Specifically, if, for example, the “information 17Ec on the accessory” is recorded as an output object in the output object information 16c, the information 17Ec on the accessory, the information 17Ef on the content of the other service, and the information 17Eg on the accessory of the other service are output.

Further, the server 14 has an AI information recording means X2 in which specific information collected from various databases by artificial intelligence (AI) based on the service provider information recorded in the service provider information recording means 16 and the information provider information recorded in the information provider information recording means 17 is recorded. Here, the “specific information” is, for example, information related to a quality of a service provided by a service provider, etc., and is not restricted in particular.

Incidentally, if it is made possible for information provider information to be changed by just a judgment of an information provider, a service provider may be put at a great disadvantage depending on a content of the information after the change. As such a case, that in which a content is made desirable to the service provider in a new recording to make the service provider select it and thereafter changed to false information with ill intent, etc., can be cited as an example. Therefore, in regard to a change of information provider information, an arrangement may be made such that the information provider can make it on his/her own but the change is reflected only when the content of the change is approved by the service provider. In addition, in a case of a new recording (and not a change of recorded information), an arrangement for approval, etc., is unnecessary because information is not output unless the service provider selects it.

Further, the server 14 has a point granting means 19 that grants points to an information provider when the accessory information outputting means 18 outputs information on an accessory, etc. Specifically, for example, if the information 17Ec on the accessory, the information 17Ff on the content of the other service, and the information 17Eg on the accessory of the other service are output, points in accordance with the information 17Ed on the return rate are added to the information 17Ee on the points held in the information provider information recording means 17E.

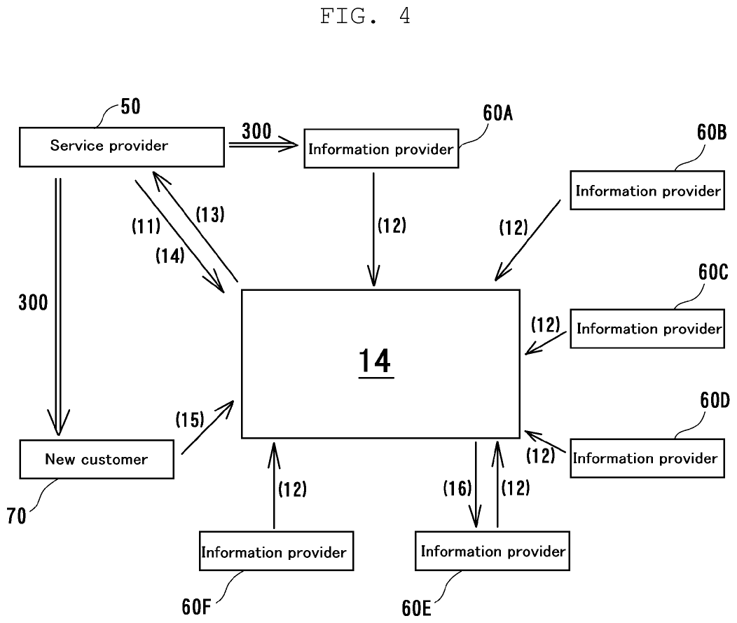

FIG. 4 is an outline view showing an example of a method for using the service information providing system according to the present invention. In the following, a description shall be provided on a premise that each of information providers 60 (60A, 60B, 60C, 60D, 60E, and 60F) has been provided with a service from a service provider 50 in the past and a new customer 70 performs collection of information in examining whether or not to be provided with a service from the service provider 50.

[1. Recording of Various Information]

In the example of the method for using the service information providing system according to the present invention, various information must be recorded in the server 14 for the new customer 70 to obtain information. Recording of the various information into the server 14 shall thus be described.

First, the service provider 50 uses the service provider terminal 12 to record a content of a service that he/she himself/herself provides (the information 16a on the content of the service) in the service provider information recording means 16. Also, the service provider 50 uses the service provider terminal 12 to record a contract content of the service that he/she himself/herself provides (the information 16b on the accessory) in the service provider information recording means 16. These recordings correspond to a step indicated by a symbol (11) in FIG. 4.

Next, the service provider 50 provides a service 300 to the information provider 60A.

Subsequently, the information provider 60A uses the information provider terminal 13A to record information specifying him/herself (the information 17Aa on the information provider) in the information provider information recording means 17A. Also, a content of the service 300 provided from the service provider 50 (the information 17Ab on the content of the service) and a contract content for receiving the service provided from the service provider 50 (the information 17Ac on the accessory) are recorded in association with the information 17Aa on the information provider in the information provider information recording means 17A using the information provider terminal 13A.

Also, a content of another service of the same type and same category as the service 300 (the information 17Af on the content of the other service) and a contract content for receiving the other service (the information 17Ag on the accessory) are recorded in association with the information 17Aa on the information provider in the information provider information recording means 17A using the information provider terminal 13A.

Here, the other service (the service of the same type and same category as the service 300) may be that provided by the service provider 50 or may be that provided by a service provider differing from the service provider 50.

Further, the information 17Ad on the return rate when the information 17Ac on the accessory, the information 17Af on the content of the other service, and the information 17Ag on the accessory of the other service are used is recorded in association with the information 17Aa on the information provider in the information provider information recording means 17A using the information provider terminal 13A. These recordings correspond to a step indicated by a symbol (12) in FIG. 4.

Also, the information provider 60A may record various information that enable the quality of the service 300 to be ascertained. For example, actual conditions and policy of business, actual conditions of organization, actual conditions of transactions, etc., of the service provider 50 can be cited. By the information provider 60A recording information that could only have been obtained by actually transacting with the service provider 50, visualization of the reality of the service provider 50 is made possible.

In addition, when the information provider 60A records the various information, a “statement to that effect” is transmitted to the service provider 50 (step indicated by a symbol (13) in FIG. 4).

Although a case where the information provider 60A records the information 17Aa on the information provider, the information 17Ab on the content of the service, the information 17Ac on the accessory, the information 17Ad on the return rate, the information 17Af on the content of the other service, and the information 17Ag on the accessory of the other service is described here, the information provider 60B, the information provider 60C, the information provider 60D, the information provider 60E, and the information provider 60F also perform recordings similarly. Here, the recordings are not meant to be performed by the information providers 60A to 60F at the same timing but are performed successively after receipt of the service from the service provider 50.

Next, as a consequence of the “statement to that effect” being transmitted in the step indicated by (13), the service provider 50 accesses the server 14 and upon checking the recorded information provider information 60 (60A to 60F), selects one of the information provider information (for example, selects the information provider information by comparing the quality of the information on the accessory or selects the information provider information by comparing the return rate, etc.) and uses the service provider terminal 12 to record the output object information 16c (step indicated by a symbol (14) in FIG. 2).

After the recording of the various information such as those described above, it becomes possible to provide the various information to the new customer 70.

In addition, although just a case where the information providers 60 perform the recordings of the various information in regard to the service 300 provided by the service provider 50 is described here, the information recorded in the server 14 is not just that related to the “service 300 provided by the service provider 50” but those related to a “service provided by the service provider 50 other than the service 300” and a “service provided by a service provider other than the service provider 50” are also recorded. That is, although with the present embodiment, a case where the new customer 70 obtains information related to the service 300 provided by the service provider 50 is described as an example (below), the server 14 can also provide information related to a “service provided by the service provider 50 other than the service 300” and a “service provided by a service provider other than the service provider 50.”

[2. Providing of Various Information]

The new customer 70 who desires to be provided with various information in relation to the service 300 provided by the service provider 50 accesses the server 14 via the internet 15 by a new customer terminal (not shown) (step indicated by a symbol (15) in FIG. 4).

When the server 14 is accessed, a list of service providers capable of providing information is displayed on the new customer terminal and the new customer 70 selects the “service provider 50” from within the displayed list. Also, when the “service provider 50” is selected, a list of services provided by the service provider 50 is displayed, and the new customer 70 selects the “service 300” from within the displayed list.

Then, when the “service 300 of the service provider 50” is selected from the new customer terminal, the accessory information outputting means 18 outputs the information 16a on the content of the service recorded in the service provider information recording means 16 (the information corresponding to the service 300 is the information 16a on the content of the service) and the information 16b on the accessory associated with the information 16a on the content of the service (the information is displayed on the new customer terminal).

Together with the above, the accessory information outputting means 18 outputs information provider information based on the output object information 16c associated with the information 16a on the content of the service (the information is displayed on the new customer terminal). Specifically, if, for example, the “information 17Ec on the accessory” is recorded as an output object in the output object information 16c, the information 17Ec on the accessory, the information 17Eb on the content of the service associated with the information 17Ec on the accessory, the information 17Ef on the content of the other service, and the information 17Eg on the accessory of the other service are output.

Also, information recorded in the AI information recording means X2 is output to the new customer 70 accessing the server 14 (the information is displayed on the new customer terminal).

Thereafter, if the new customer 70 is to be provided with the service 300 of the service provider 50 (if the service 300 of the service provider 50 is to be purchased), the service provider 50 provides the service 300 to the new customer 70.

In addition, when the accessory information outputting means 18 outputs the information, a “statement to that effect” is transmitted to an information provider (step indicated by a symbol (16) in FIG. 4 in a case of transmission to the information provider 17E).

[3. Granting of Points]

When the accessory information outputting means 18 outputs the information, the point granting means 19 grants points to a party that registered the information output by the accessory information outputting means 18. Specifically, for example, if the accessory information outputting means 18 outputs the information 17Ec on the accessory, points corresponding to a price obtained by multiplying a “price of the service 300 of the service provider 50” by the information 17Ed on the return rate are granted and the information 17Ee on the points held becomes renewed.

[Effect(s)]

With the service information providing system according to the present invention described above, the price and the contract content of the service 300 of the service provider 50 can be ascertained by the information 17Ec on the accessory. Further, by the information 17Ef on the content of the other service and the information 17Eg on the accessory of the other service, the service 300 can be compared with the other service to ascertain the price and the contract content. In addition, before being provided with the service 300, the price and the contract content of the service 300 can be ascertained by checking the information 17Ec on the accessory, etc., and therefore, the new customer 70 can obtain a material for judging whether or not to receive the service 300 of the service provider 50 (whether or not to purchase the service 300).

Also, by both the information 16b on the accessory and the information 17Ec on the accessory being output and by specifying the price and the contact contract of the service 300 based on the information of both the party providing the service (service provider 50) and the party provided with the service (information provider 60E), alteration or forgery, etc., of information can be suppressed.

Similarly, by both the information 16a on the content of the service and the information 17Eb on the content of the service being output and by specifying the content of the service 300 based on the information of both the party providing the service (service provider 50) and the party provided with the service (information provider 60E), alteration or forgery, etc., of information can be suppressed.

Also, by points being granted to the information providers, enhancement of each information provider's wish to register information provider information and improvement of information provider information (improvement of numerical quantity and improvement of quality) can be anticipated and consequently, it is made possible to ascertain the price and the contact contract of the service 300 even more through the accessory.

Also, due to each information provider being able to register the information on the accessory and the information on the return rate on his/her own and points being granted for just the information provider information selected by the service provider 50, improvement of the quality of the information provider information can be anticipated, and even by this aspect, it is made possible to ascertain the price and the contact contract of the service 300 even more through the accessory.

### MODIFICATION EXAMPLE 1

Although with the example of the service information providing system according to the present invention described above, a case where the information 17Ec on the accessory is output is described as an example, since it suffices that the new customer 70 be able to check the information on the accessory, identification information (an identifier such as a two-dimensional barcode, a color code, etc.) that enables access to the information 17Ec on the accessory may be output instead. In this case, the identification information is used to access, by the new customer terminal, a website, etc., on which the information 17Ec on the accessory is posted to check the information 17Ec on the accessory.

Here, in a case where the information 17Ec on the accessory is to be accessed through identification information as in Modification Example 1, even when the information 17Ec on the accessory in the information provider information recording means 17E is changed, an arrangement may be made, in consideration of a new customer's anticipation that the same information would be posted in the accessed website, such that the information 17Ec on the accessory before the change is posted in the website accessed by the identification information output before the change.

### MODIFICATION EXAMPLE 2

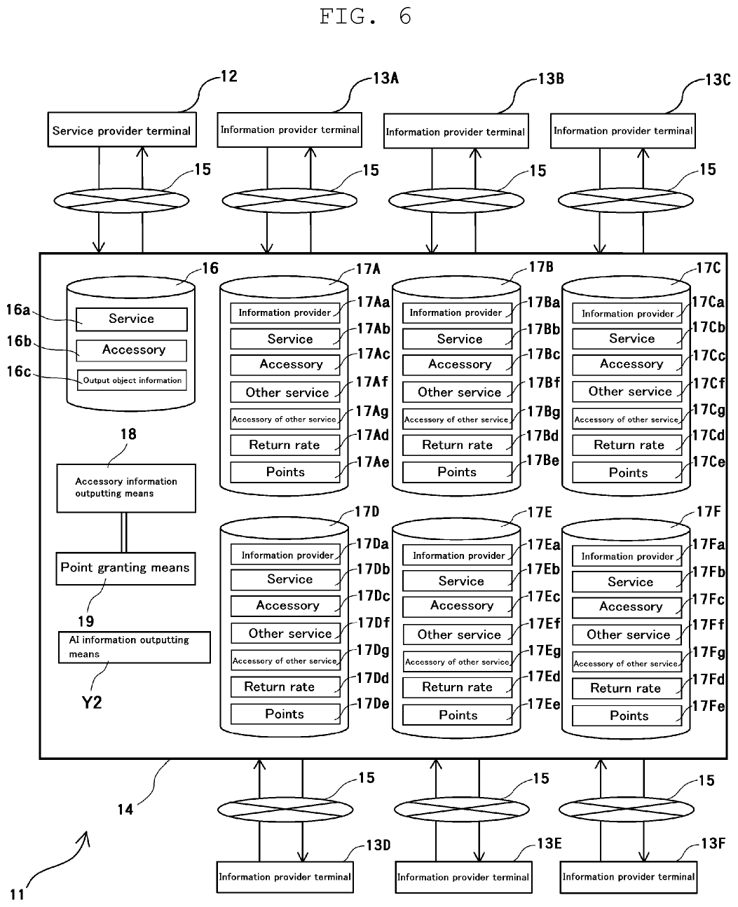

Also, in place of the AI information recording means X2 in the example of the service information providing system according to the present invention described above, the system may have an AI information outputting means Y2 that provides, to the new customer 70 accessing the server 4, specific information collected from various databases by artificial intelligence (AI) (in other words, displays the specific information collected from various databases by AI on the new customer terminal) based on the service provider information recorded in the service provider information recording means 16 and the information provider information recorded in the information provider information recording means 17 (see FIG. 6).

### DESCRIPTION OF REFERENCE NUMERALS

1 product information providing system

2 merchandise provider terminal

3 information provider terminal

4 server

5 internet

6 merchandise provider information recording means

7 information provider information recording means

8 accessory information outputting means

9 point granting means

11 service information providing system

12 service provider terminal

13 information provider terminal

14 server

15 internet

16 service provider information recording means

17 information provider information recording means

18 accessory information outputting means

19 point granting means

20 service provider

30 information provider

40 new customer

50 service provider

60 information provider

70 new customer

200 merchandise

201 accessory

300 service

X1 AI information recording means

X2 AI information recording means

Y1 AI information outputting means

Y2 AI information outputting means

1. A product information providing system comprising:
a merchandise provider information recording means that is configured to record merchandise provider information that is transmitted from a terminal of a merchandise provider, wherein the merchandise provider information includes content information on a content of a specific merchandise provided from the merchandise provider;
an information provider information recording means that is configured to record information provider information that is transmitted from a terminal of an information provider, which differs from the terminal of the merchandise provider, and wherein the information provider information includes the content information and an accessory information on an accessory to understand a quality of the specific merchandise provided from the merchandise provider;
an accessory information outputting means that is configured to outputa the accessory information from a selected information provider information, wherein the selected information provider information is the information provider information that is selected by the merchandise provider from among the information provider information that has been recorded by the information provider information recording means, or is an identification information that enables access to the accessory information;
a point granting means that is configured to grant a point to the information provider for whom the accessory information is used by the accessory information outputting means that outputs the accessory information; and
an AI information recording means that record, via artificial intelligence, specific information as AI information, wherein the AI information includes at least a portion of the merchandise provider information, at least a portion of the information provider information, or at least the portion of the merchandise provider information and at least the portion of the information provider information; or
an AI information outputting means that outputs, via the artificial intelligence, the AI information.

2. The product information providing system according to claim 1, wherein the information provider information further includes a return rate information hat corresponds to a rate of when the accessory information is used, and
wherein the point granting means is further configured to grant a point in accordance with the return rate information that is included in the selected information provider information.

3. The product information providing system according to claim 1, wherein the information provider information further includes information on another merchandise of a same type and category as the specific merchandise provided from the merchandise provider.

4. The product information providing system according to claim 1, wherein the merchandise provider information further includes the accessory information.

5. The product information providing system according to claim 1, wherein the merchandise provider information recording means differs from the information provider information recording means.

6. The product information providing system according to claim 1, wherein the merchandise provider information further includes specifying information which specifies the selected information provider information, the accessory information outputting means, and the point granting means that are functioning based on the specifying information.

7. A product information providing system comprising:
an information provider information recording means that is configured to record information provider information that is transmitted from a terminal of an information provider, wherein the information provider information includes an accessory information on an accessory, wherein the accessory information includes information to understand a quality of a merchandise provided from the merchandise provider;
an accessory information outputting means that is configured to output the accessory information from a selected information provider information, wherein the selected information provider information is the information provider information that is selected by the merchandise provider from among the information provider information that has been recorded by the information provider information recording means, or is an identification information that enables access to the accessory information;
a point granting means that is configured to grant-a a point to the information provider for whom the accessory information is used by the accessory information outputting means that outputs the accessory information; and
an AI information recording means that records, via artificial intelligence, specific information as AI information, wherein the AI information includes at least a portion of the information provider information; or
an AI information outputting means that outputs, via the artificial intelligence, the specific information as the AI information.

8. The product information providing system according to claim 7, wherein the information provider information further includes a return rate information that corresponds to a rate of when the accessory information is used, and
wherein the point granting means is further configured to grant a point in accordance with the return rate information that is included in the selected information provider information.

9. The product information providing system according to claim 7, wherein the information provider information further includes information on another merchandise of a same type and category as the specific merchandise provided from the merchandise provider.

10. A service information providing system comprising:
a service provider information recording means that is configured to record service provider information that is transmitted from a terminal of a service provider, wherein the service provider information includes content information on a content of a specific service;
an information provider information recording means that is configured to record information provider information that is transmitted from a terminal of an information provider, which differs from the terminal of the service provider, wherein the information provider information includes the content information and an accessory information on an accessory to understand a quality of the specific service provided from the service provider;
an accessory information outputting means that is configured to output the accessory information from a selected information provider information, wherein the selected provider information is the information provider information that is selected by the service provider from among the information provider information that has been recorded by the information provider information recording means, or is an identification information that enables access to the accessory information;
a point granting means that is configured to grant a point to the information provider for whom the accessory information is used by the accessory information outputting means that outputs the accessory information; and
an AI information recording means that records, via artificial intelligence, AI information, which the AI information includes at least a portion of the service provider information, at least a portion of the information provider information, or at least the portion of the service provider information and at least the portion of the information provider information; or
an AI information outputting means that outputs, via artificial intelligence, the AI information.

11. The service information providing system according to claim 10, wherein the information provider information further includes a return rate information that corresponds to a rate of when the accessory information is used, and
wherein the point granting means is further configured to grants a point in accordance with the return rate information that is included in the selected information provider information.

12. The service information providing system according to claim 10, wherein the information provider information includes information on another service of a same type and category as the specific service provided from the service provider.

13. The service information providing system according to claim 10, wherein the service provider information further includes the accessory information.

14. The service information providing system according to claim 10, wherein the service provider information recording means differs from the information provider information recording means.

15. The service information providing system according to claim 10, wherein the service provider information further includes specifying information which specifies the selected information provider information, the accessory information outputting means, and the point granting means that are functioning based on the specifying information.

16. A service information providing system comprising:
an information provider information recording means that is configured to record information provider information that is transmitted from a terminal of an information provider, wherein the information provider information includes an accessory information on an accessory, wherein the accessory information includes information to understand a quality of a service provided from the service provider;
an accessory information outputting means that is configured to output the accessory information from a selected information provider information, wherein the selected information provider information is the information provider information that is selected by the service provider from among the information provider information that has been recorded by the information provider information recording means, or is an identification information that enables access to the accessory information;
a point granting means that is configured to grant a point to the information provider for whom the accessory information is used by the accessory information outputting means that outputs the accessory information; and
an AI information recording means that records, via artificial intelligence, specific information as AI information, wherein the AI information includes at least a portion of the information provider information; or
an AI information outputting means that outputs, via the artificial intelligence, the specific information as the AI information.

17. The service information providing system according to claim 16, wherein the information provider information further includes a return rate information that corresponds to a rate of when the accessory information is used,
wherein and the point granting means is further configured to grant a point in accordance with the return rate information that is included in the selected information provider information.

18. The service information providing system according to claim 16, wherein the information provider information includes information on another service of a same type and category as the service provided from the service provider.

19. A product information providing system comprising:
a merchandise provider information recording means that is configured to record merchandise provider information that is transmitted from a terminal of a merchandise provider, wherein the merchandise provider information includes content information on a content of a specific merchandise provided from the merchandise provider;
an information provider information recording means that is configured to record information provider information that is transmitted from a terminal of an information provider, which differs from the merchandise provider, and wherein the information provider information includes the content information and an accessory information on an accessory to understand a contract, wherein the contract includes at least one of either a price of the merchandise provided from the merchandise provider or a contract content for the specific merchandise to be provided from the merchandise provider;
an accessory information outputting means that is configured to outputa the accessory information from a selected information provider information, wherein the selected information provider information is the information provider information that is selected by the merchandise provider from among the information provider information that has been recorded by the information provider information recording means, or is an identification information that enables access to the accessory information;
a point granting means that is configured to grants a point to the information provider for whom the accessory information is used by the accessory information outputting means that outputs the accessory information; and
an AI information recording means that records, via artificial intelligence, specific information as AI information, wherein the AI information includes at least a portion of the merchandise provider information, at least a portion of the information provider information, or at least the portion of the merchandise provider information and at least the portion of the information provider information; or
an AI information outputting means that is configured to output, via the artificial intelligence, the specific information as the AI information.

20. The product information providing system according to claim 19, wherein the information provider information further includes a return rate information that corresponds to a rate of when the accessory information is used, and
wherein the point granting means is further configured to grants a point in accordance with the return rate information that is included in the selected information provider information.

21. The product information providing system according to claim 19, wherein the information provider information further includes information on another merchandise of a same type and category as the specific merchandise provided from the merchandise provider.

22. The product information providing system according to claim 19, wherein the merchandise provider information further includes the accessory information.

23. The product information providing system according to claim 19, wherein the merchandise provider information recording means differs from the information provider information recording means.

24. The product information providing system according to claim 19, wherein the merchandise provider information further includes specifying information which specifies the selected information provider information, the accessory information outputting means, and the point granting means that are functioning based on the specifying information.

25. A product information providing system comprising:
an information provider information recording means that is configured to record information provider information that is transmitted from a terminal of an information provider differing from a merchandise provider, wherein the information provider information includes an accessory information on an accessory, wherein the accessory information includes information to understand a contract, wherein the contract includes at least one of either a price of a merchandise provided from the merchandise provider or a contract content for the merchandise to be provided from the merchandise provider;
an accessory information outputting means that is configured to output the accessory information from a selected information provider information, wherein the selected information provider information is the information provider information that is selected by the merchandise provider from among the information provider information that has been recorded in the information provider information recording means, or is an identification information that enables access to the accessory information;
a point granting means that is configured to grant a point to the information provider for whom the accessory information is used by the accessory information outputting means that outputs the accessory information; and
an AI information recording means that records, via artificial intelligence, specific information as AI information, wherein the AI information includes at least a portion of the information provider information; or
an AI information outputting means that outputs, via the artificial intelligence, the specific information as the AI information.

26. The product information providing system according to claim 25, wherein the information provider information further includes a return rate information that corresponds to a rate of when the accessory information is used, and
wherein the point granting means is further configured to grant a point in accordance with the return rate information that is included in the selected information provider information.

27. The product information providing system according to claim 25, wherein the information provider information includes information on another merchandise of a same type and category as the merchandise provided from the merchandise provider.

28. A service information providing system comprising:
a service provider information recording means that is configured to record service provider information that is transmitted from a terminal of a service provider, wherein the service provider information includes content information on a content of a specific service provided by the service provider;
an information provider information recording means that is configured to record information provider information that is transmitted from a terminal of an information provider, which differs from the terminal of the service provider, and wherein the information provider information includes the content information and an accessory information on an accessory to understand a contract, wherein the contract includes at least one of either a price of the specific service provided from the service provider or a contract content for the specific service to be provided from the service provider;
an accessory information outputting means that is configured to output the accessory information from a selected information provider information, wherein the selected information provider information is the information provider information that is selected by the service provider from among the information provider information that has been recorded by the information provider information recording means, or is an identification information that enables access to the accessory information;
a point granting means that is configured to grant a point to the information provider for whom the accessory information is used by the accessory information outputting means that outputs the accessory information; and
an AI information recording means that records, via artificial intelligence, specific information as AI information, wherein the AI information includes at least a portion of the service provider information, at least a portion of the information provider information, or at least the portion of the service provider information and at least the portion of the information provider information; or
an AI information outputting means that is configured to output, via the artificial intelligence, the specific information as the AI information.

29. The service information providing system according to claim 28, wherein the information provider information further includes a return rate information corresponding to a rate when the accessory information on is used, and
wherein the point granting means is further configured to grant a point in accordance with the return rate information that is included in the selected information provider information.

30. The service information providing system according to claim 28, wherein the information provider information further includes information on another service of a same type and category as the specific service provided from the service provider.

31. The service information providing system according to claim 28, wherein the service provider information further includes the accessory information.

32. The service information providing system according to claim 28, wherein the service provider information recording means differs from the information provider information recording means.

33. The service information providing system according to claim 28, wherein the service provider information further includes specifying information which specifies the selected information provider information, the accessory information outputting means, and the point granting means that are functioning based on the specifying information.

34. A service information providing system comprising:
an information provider information recording means that is configured to record information provider information that is transmitted from a terminal of an information provider, wherein the information provider information includes an accessory information on an accessory to understand a contract, wherein the contract includes at least one of either a price of a service provided from the service provider or a contract content for the service to be provided from the service provider;
an accessory information outputting means that is configured to output the accessory information from a selected information provider information, wherein the selected information provider information is the information provider information selected by the service provider from among the information provider information that has been recorded by the information provider information recording means, or is an identification information that enables access to the accessory informatio;
a point granting means that is configured to grant a point to the information provider for whom the accessory information is used by the accessory information outputting means that outputs the accessory information; and
an AI information recording means that records, via artificial intelligence, specific information as AI information, wherein the AI information includes at least a portion of the information provider information; or
an AI information outputting means that outputs, via the artificial intelligence, the specific information as the AI information.

35. The service information providing system according to claim 34, wherein the information provider information includes a return rate information that corresponds to a rate of when the accessory information is used, and
wherein the point granting means is further configured to grant a point in accordance with the return rate information that is included in the selected information provider information.

36. The service information providing system according to claim 34, wherein the information provider information includes information on another service of a same type and category as the service provided from the service provider.
